(19) United States
(12) Patent Application Publication
(10) Pub. No.: US 2007/0124602 A1
(43) Pub. Date: May 31, 2007

(54) Multimedia storage and access protocol

(76) Inventors: Stephanie Wald, Givat Zeev (IL); Yossi Tsuria, Jerusalem (IL); Ezra Darshan, Beit Shemesh (IL); Aviad Kipnis, Jerusalem (IL); David Richardson, Ramat Hasharon (IL); Victor Halperin, Maaleh Adumim (IL)

Correspondence Address: LADAS & PARRY, 26 WEST 61ST STREET, NEW YORK, NY, 10023, US

(21) Appl. No.: 10/558,527

(22) PCT Filed: Apr. 18, 2004
(86) PCT No.: PCT/IL04/00334

§ 371 Date: Dec. 20, 2006

Related U.S. Application Data
(60) Provisional application No. 60/478,844, filed on Jun. 17, 2003.

(51) Int. Cl. H04L 9/32; H04N 7/16; G06Q 99/00; G06F 12/14; G06F 17/30; G06F 7/04; H04L 9/00; G06F 11/30; G06K 9/00; H04K 1/00; H03M 1/68

(52) U.S. Cl. 713/193; 705/59; 726/27; 726/28; 726/29

(57) ABSTRACT

A method for protecting content including providing a host, a player, a communications link between host and player for communicating content therebetween, a recordable medium adapted to be played by and recorded to by the player, and an encrypted item of content, and producing a secure content license corresponding to the content, the license including a key for accessing the content, a permission list for determining whether the host or the player is allowed to access the content under pre-defined circumstances, the circumstances including a type of use of the encrypted content, an identification of the recordable medium, the recordable medium identification generated in accordance with a predefined recordable medium identification generation algorithm, and describing at least one physical characteristic of the recordable medium, and an identification of the content, the item identification describing at least one data characteristic of the content.

### CROSS-REFERENCE TO RELATED APPLICATIONS

This application claims the benefit of U.S. Provisional Patent Application Ser. No. 60/478,844, filed Jun. 17, 2003, entitled “Multimedia Storage and Access Protocol,” and incorporated herein by reference in its entirety.

### BACKGROUND OF INVENTION

Television has already moved into the area of storage, with the digital video recorder that has a built-in hard disk. The disks in use today range from 20 Gigabytes to 200 Gigabytes or more, but it is easy to see that high definition TV will require much larger storage capability. Furthermore, as digital piracy becomes more sophisticated and ubiquitous, new techniques must be developed to provide access to ever greater amounts of content in a controlled and secure manner. Similarly, other multimedia platforms, such as game platforms, are also supplied in digital format having their own storage and have similar piracy problems.

The disclosures of all references mentioned throughout the present specification, as well as the disclosures of all references mentioned in those references, are hereby incorporated herein by reference.

### SUMMARY OF THE INVENTION

The present invention provides for a multimedia storage and access protocol in which content protection is implemented for a mass storage device that is capable of storing, for example, one terabyte of data, equivalent to approximately 1,000 hrs of MPEG2 standard definition video and audio.

The mass storage device of the present invention is preferably a removable mass storage (RMS) device which is insertable into, removable from, and accessible via a dedicated drive, referred to herein as an RMS Player, which is configured to both read from and write to the RMS.

In order to simplify the RMS Player functionality, it may be integrated into an STB-PVR system such as the XTV™ system, commercially available from NDS Limited, One London Road, Staines, Middlesex TW18 4EX United Kingdom. This integration may be by means of either an internal or external RMS Player. The RMS Player may be directly connected to digital playout devices such as a digital TV, and to other devices in a home network. The RMS Player may be used in conjunction with a device that includes a Secure Video Processor (SVP) technology commercially available from NDS Limited. The RMS Player can also interface with other existing Digital Rights Management (DRM) systems.

The RMS may have a licensing arrangement similar to that for DVD player and disk production. Raw RMS media, such as optical disks, may be post-processed in a secure facility which prepares them for use, such as by pre-loading content onto the RMS.

In one aspect of the present invention a method is provided for protecting content, the method including providing a host, a player, a communications link between the host and the player for communicating content therebetween, a recordable medium adapted to be played by and recorded to by the player, and an encrypted item of content, and producing a secure content license corresponding to the item of content, the secure content license including a key for accessing the item of content, a permission list for determining whether either of the host and the player is allowed to access the item of content under pre-defined circumstances, the circumstances including a type of use of the encrypted item of content, an identification of the recordable medium, the recordable medium identification generated in accordance with a predefined recordable medium identification generation algorithm and describing at least one physical characteristic of the recordable medium, and an identification of the item of content, the item identification describing at least one data characteristic of the item of content.

In another aspect of the present invention the providing step includes storing the item of content on the recordable medium in advance of the player first accessing the content.

In another aspect of the present invention the storing step includes storing an indicator on the recordable medium indicating that the item of content is pre-authorized for access by the player.

In another aspect of the present invention the providing step includes configuring the host to support Secure Video Processor (SVP) protocols.

In another aspect of the present invention the providing step includes configuring the host to receive content via a conditional access (CA) gateway.

In another aspect of the present invention the providing step includes configuring the host to support Secure Video Processor (SVP) protocols and receive content via a conditional access (CA) gateway.

In another aspect of the present invention the providing step includes configuring the player to support Secure Video Processor (SVP) protocols.

In another aspect of the present invention the providing step includes configuring the player to receive CA gateway content from the host.

In another aspect of the present invention the method further includes detecting the presence or absence of an indicator on the recordable medium indicating that the item of content is pre-authorized for access by the player, requesting, if the indicator is not detected on the recordable medium, authorization for the player to access the item of content.

In another aspect of the present invention the method further includes storing a location indicator of an authorization service center within the content license,

In another aspect of the present invention the requesting step includes sending the content license to the authorization service center at the location, receiving a modified content license from the authorization service center including an authorization for the player to access the item of content.

In another aspect of the present invention the storing a location indicator step includes storing a URL of the authorization service center within the content license.

In another aspect of the present invention the producing step includes generating the identification of the item of content as a mathematical function of at least a portion of the item of content.

In another aspect of the present invention the producing step includes generating the recordable medium identifier that is unique to the recordable medium in accordance with a predefined statistical likelihood.

In another aspect of the present invention the generating step includes generating as part of a formatting process of the recordable medium.

In another aspect of the present invention the method further includes storing the recordable medium identifier on the recordable medium.

In another aspect of the present invention the method further includes generating a comparison identification of the recordable medium in accordance with the predefined recordable medium identification generation algorithm and describing the at least one physical characteristic of the recordable medium, comparing the recordable medium identification with the comparison identification, and validating the recordable medium if the recordable medium identification and the comparison identification are identical within a predefined tolerance.

In another aspect of the present invention the method further includes preventing access to the recordable medium if the recordable medium identification and the comparison identification are not identical within the predefined tolerance.

In another aspect of the present invention the method further includes creating a certificate for the recordable medium, the certificate including the recordable medium identification and a recordable medium public key.

In another aspect of the present invention the creating a certificate step includes creating the recordable medium certificate including a list of restrictions indicating permissible uses of the recordable medium.

In another aspect of the present invention the creating a certificate step includes creating the restrictions to include any of the following restrictions the recordable medium does not allow local recording, the recordable medium permits local recording, and the recordable medium permits recording content from at least one specified content provider only.

In another aspect of the present invention the method further includes signing the recordable medium certificate with a signing key of the manufacturer of the recordable medium.

In another aspect of the present invention the method further includes validating the recordable medium certificate signature with a public key of the authorized manufacturer or producer of the recordable medium.

In another aspect of the present invention the method further includes storing a certificate for the manufacturer of the recordable medium certificate on the recordable medium.

In another aspect of the present invention the method further includes signing a chain of certificates from the recordable medium manufacturer's certificate to a root certificate with a corresponding chain of signing keys

In another aspect of the present invention the method further includes storing the chain of certificates on the recordable medium.

In another aspect of the present invention the method further includes signing any of the chain of certificates with a recordable medium private key.

In another aspect of the present invention the method further includes validating the chain of certificates with corresponding chain of public keys.

In another aspect of the present invention the providing step includes providing the recordable medium having any of the following: a list of revoked devices, a software update for the player, a data update for the player, and a list of public keys of other devices for encrypting any items of content on the recordable medium or other recordable media for use with the other devices.

In another aspect of the present invention the producing step includes producing the secure content license having a Content Segment License (CSL) corresponding to a specific segment of the unit of content, a Content User License (CUL) specifying user permissions with respect to the unit of content, and a Baseline Entitlement Control Message (BL-ECM) including an indication of a control word for decrypting the unit of content.

In another aspect of the present invention the method further includes creating a directory of data stored on the recordable medium, and signing the directory with either of a signing key of an authorized manufacturer of the recordable medium where the content is pre-loaded onto the recordable medium, and a secure processor key of the player where the content is stored to the recordable medium by the player.

In another aspect of the present invention the method further includes configuring the player to receive content from the host for recording onto the recordable medium, and to receive from the host a content restriction imposed by or on the host for preserving by the player.

In another aspect of the present invention the configuring step includes configuring the player to permit playout of content received from the host to any of a plurality of hosts exclusively from the recordable medium where the content restriction indicates that content may be played out via a plurality of hosts.

In another aspect of the present invention the method further includes rendering the content exclusively accessible to at least one player in a domain of players, and storing the item of content onto the recordable medium.

In another aspect of the present invention the rendering and storing steps are performed by the player.

In another aspect of the present invention the rendering step includes any of transmitting a list of players in the domain to the host together with the content, storing the list at the host, and receiving the list generated by a user.

In another aspect of the present invention a plurality of public keys corresponding to the list of players are read from a list stored on the recordable media of corresponding player IDs for selection by a user via either of a label affixed to the player and a user interface menu.

In another aspect of the present invention a plurality of public keys corresponding to the list of players are received from each of the players belonging to the domain.

In another aspect of the present invention the method further includes storing the item of content on the recordable medium where the content is received via broadcast, multicast or unicast, and configuring either of the recordable medium and the content to allow playback of the content stored on the recordable medium by any player.

In another aspect of the present invention the method further includes configuring the content with a regional restriction specifying at least one region that is allowed to or disallowed from accessing the content, and configuring the player to maintain a record of the regions to which it belongs and allow either of storage and playback of the content where the player belongs to the region specified in the regional restriction.

In another aspect of the present invention the configuring content step includes specifying either of a geographic region and a logically defined region.

In another aspect of the present invention the method further includes storing the item of content on the recordable medium, and configuring either of the recordable medium and the content to allow playback of the content stored on the recordable medium by any player and to prevent subsequent storage of the content onto another device.

In another aspect of the present invention the method further includes configuring the player to permit a personal copy of the content to be stored to recordable medium and distributed only to an SVP-compliant device for immediate viewing thereat, where the SVP-compliant device is configured to prevent local storing of the content or output of the content to any other device.

In another aspect of the present invention the method further includes configuring the content license to include data required for an SVP-compliant content license and BL-ECM.

In another aspect of the present invention the method further includes configuring the recordable medium to permit storage thereto of content originating exclusively from a predefined source.

In another aspect of the present invention the providing step includes storing the item of content on the recordable medium in advance of the player first accessing the content, and where the configuring step includes configuring the recordable medium to permit storage thereto of content originating exclusively from the source of the stored content.

In another aspect of the present invention the method further includes associating a password with the content, and configuring either of the player and the host to receive and validate the password prior to permitting access to the content.

In another aspect of the present invention the method further includes storing the item of content on the recordable medium in advance of the player first accessing the content, where the content is non-pre-authorized content, and decrypting with the password received from an authorization center a BL-ECM including a control word for decrypting the content.

In another aspect of the present invention the method further includes configuring the player to disallow access to the content if a current date received from an authorized time source is later than a final expiration date specified in the content license.

In another aspect of the present invention the method further includes configuring the player to permit access to the content if a current date received from an authorized time source is not later than a final expiration date specified in the content license.

In another aspect of the present invention a method is provided for validating content stored on a storage medium, the method including validating a content storage medium by accessing a certificate stored on a content storage medium, determining that an identifier in the certificate matches the results of an algorithm applied to physical properties of the content storage medium, determining that the certificate is properly signed, and if the content storage medium is valid, validating content stored on the content storage medium by accessing a content license associated with an item of content stored on the content storage medium, the content license having a plurality of components, each component signed by a signing entity, determining that each of the components is properly signed, and decrypting a control word stored as part of the content license.

In another aspect of the present invention a method is provided for writing locally recorded content to a storage medium, the method including receiving a broadcast, multicast or unicast stream containing content and an associated content license (CL) including a content binding vector (CBV), validating the CL, and writing the content and the CL to the storage medium if the CL is valid.

In another aspect of the present invention the receiving step is performed at a host, where the validating and writing steps are performed at a player being in communication with the host, and the method further includes the host initiating a request to the player to write the content to the storage medium, sending the CL to the player, the player notifying the host that it may send the content to the player if the CL is valid, and the host sending the content to the player.

In another aspect of the present invention a method is provided for writing locally recorded content to a storage medium under conditional access (CA) control, the method including receiving a broadcast stream containing content and an associated content license (CL) including a placeholder for a content binding vector (CBV), generating a CBV for the content, replacing the placeholder with the generated CBV, and writing the content and the CL to the storage medium.

In another aspect of the present invention the receiving and replacing steps are performed at a host acting as a CA gateway, where the generating and writing steps are performed at a player being in communication with the host, and the method further includes the host sending the CL to the player, the player sending the generated CBV to the CA gateway, and the host sending the CL, including the generated CBV, to the player.

In another aspect of the present invention a method is provided for playing content stored on a storage medium, the method including querying a player for a content list stored on a storage medium, sending a request to the player to play a content item selected from the content list, determining whether the content item is pre-authorized, validating a content license (CL) associated with the content item if the content item is pre-authorized, and playing the content item if the content item is pre-authorized.

In another aspect of the present invention a method is provided for playing non-pre-authorized content stored on a storage medium, the method including sending a content license (CL) of a non-pre-authorized content item to an authorization service center, providing payment information to the authorization service center, receiving an updated CL with content decryption information from the authorization service center, validating the CL, and providing access to the content if the CL is valid.

In another aspect of the present invention a method is provided for writing content stored on a storage medium, the method including receiving a request from a requestor to provide content stored on a storage medium for copying by the requestor, validating a content license (CL) associated with the requested content, determining from the validated CL if the requester is permitted to write the requested content, and providing the requested content to the requestor for writing thereby.

In another aspect of the present invention a method is provided for writing content to a storage medium without a content license (CL) and reading content therefrom, the method including providing a first encryption key, generating a second encryption key for an item of content, encrypting the content with the generated second encryption key, encrypting the generated second encryption key with the first encryption key, and storing the encrypted content and the generated second encryption key to a storage medium.

In another aspect of the present invention the providing step includes storing the first encryption key in a player, and where any other of the steps are performed by the player.

In another aspect of the present invention the method further includes decrypting the second encryption key with the first encryption key if no CL is detected for the content, decrypting the content with the decrypted first encryption key, and providing the decrypted content to a requestor.

In another aspect of the present invention a method is provided for generating a content license (CL), the method including a) creating and signing a Content Segment License (CSL) corresponding to a specific segment of the unit of content, b) creating and signing a Content User License (CUL) specifying user permissions with respect to the unit of content, c) creating, signing, and encrypting a Baseline Entitlement Control Message (BL-ECM) including an indication of a control word for decrypting the unit of content, d) creating a CL incorporating the CSL, CUL, and BL-ECM, and e) encrypting the CL with a public key associated with a storage medium.

In another aspect of the present invention the creating step a) is performed by an owner of the content.

In another aspect of the present invention the creating step b) is performed by a conditional access (CA) gateway.

In another aspect of the present invention the creating step c) is performed by an encryptor of the content.

In another aspect of the present invention the creating step a) includes creating the CSL to include any of a CSL ID, a content ID, a content link, a content provider ID, an authorization service center ID, an authorization service center location, and a group authorizer public key.

In another aspect of the present invention the creating step b) includes creating the CUL to include any of a CSL ID, the public key associated with the storage medium, and a domain list.

In another aspect of the present invention the creating step c) includes creating the BL-ECM to include any of a CSL ID, an index linking the BL-ECM a corresponding location in the content, and a control word used to encrypt the content.

In another aspect of the present invention a method is provided for creating a Content Binding Vector (CBV) for a content block, the method including dividing a content block into at least one content mini block, generating a digital signature for each of the content mini blocks, and combining the digital signatures of each of the content mini blocks in the content block to form a CBV for the content block.

In another aspect of the present invention the dividing step includes dividing where the content block includes an entropy encoded MEPG video bitstream.

In another aspect of the present invention the generating step includes calculating a set of hash bits for each of the content mini blocks.

In another aspect of the present invention the calculating step includes calculating the set of hash bits using a one-way hash function.

In another aspect of the present invention the combining step includes creating a list of the digital signatures.

In another aspect of the present invention the creating step includes concatenating the digital signatures.

In another aspect of the present invention the method further includes generating an asymmetric signature of the list.

In another aspect of the present invention the generating an asymmetric signature step includes generating using a predefined field dedicated for use as the asymmetric signature.

In another aspect of the present invention the generating an asymmetric signature step includes generating using a redundancy string that is a function of the content mini block.

In another aspect of the present invention the generating an asymmetric signature step includes generating where the asymmetric signature corresponds to the entire CBV.

In another aspect of the present invention the generating an asymmetric signature step includes generating a plurality of asymmetric signatures, where each of the plurality of asymmetric signatures corresponds to a different group of bits within the CBV.

In another aspect of the present invention the method further includes protecting any of the content mini blocks by appending an error detection code (EDC) to any of the content mini blocks, thereby forming an error detectable block.

In another aspect of the present invention the method further includes identifying an error detectable block as a failed error detectable block where the error detectable block includes an error in its content bits as determined by applying a predefined CBV verification algorithm.

In another aspect of the present invention the method further includes constructing the EDC using the TCP/IP 1-complement checksum technique.

In another aspect of the present invention the method further includes constructing the EDC using the CCITT standard used for checksums.

In another aspect of the present invention the method further includes appending error detectable block to the CBV, thereby forming a storable block.

In another aspect of the present invention a method is provided for assessing the invalidity of a content signature at a first resolution relative to a first invalidity threshold, restricting access to the content if the first resolution invalidity exceeds the first invalidity threshold, assessing the invalidity of the content signature at a second resolution relative to a second invalidity threshold, and restricting access to the content if the second resolution invalidity exceeds the second invalidity threshold.

In another aspect of the present invention a method is provided for validating content, the method including validating the signature of a CBV of a content block stored in a storable block incrementing an invalid signature count if the signature is invalid, restricting access to the content block if the invalid signature count exceeds an invalidity threshold, if the invalid signature count does not exceed the invalidity threshold breaking the storable block into a plurality of content mini blocks and their corresponding error detection codes (EDC) and hash bits, validating the EDCs corresponding to each of the content mini blocks, incrementing an invalid EDC count if the EDC is invalid, restricting access to the content block if the invalid EDC count exceeds an invalid EDC count threshold, if the invalid EDC count does not exceed the invalid EDC count threshold validating the hash bits corresponding to each of the content mini blocks, incrementing an invalid hash bits count if the hash bits are invalid, restricting access to the content block if the invalid hash bits count exceeds an invalid hash bits threshold.

In another aspect of the present invention the validating EDC step includes reconstructing the EDC from the content mini block in the manner in which the EDC was constructed, and comparing the reconstructed EDC to the EDC, where validity of the EDC is established where the EDC matches the reconstructed EDC.

In another aspect of the present invention the validating hash bits step includes reconstructing the hash bits from the content mini block in the manner in which the hash bits were constructed, and comparing the reconstructed hash bits to the hash bits, where validity of the hash bits is established where the hash bits match the reconstructed hash bits.

In another aspect of the present invention a content protection system is provided including a host, a player, a communications link between the host and the player for communicating content therebetween, a recordable medium adapted to be played by and recorded to by the player, an encrypted item of content, and means for producing a secure content license corresponding to the item of content, the secure content license including a key for accessing the item of content, a permission list for determining whether either of the host and the player is allowed to access the item of content under pre-defined circumstances, the circumstances including a type of use of the encrypted item of content, an identification of the recordable medium, the recordable medium identification generated in accordance with a predefined recordable medium identification generation algorithm and describing at least one physical characteristic of the recordable medium, and an identification of the item of content, the item identification describing at least one data characteristic of the item of content.

In another aspect of the present invention the item of content is stored on the recordable medium in advance of the player first accessing the content.

In another aspect of the present invention the system further includes an indicator stored on the recordable medium indicating that the item of content is pre-authorized for access by the player.

In another aspect of the present invention the host is configured to support Secure Video Processor (SVP) protocols.

In another aspect of the present invention the host is configured to receive content via a conditional access (CA) gateway.

In another aspect of the present invention the host is configured to support Secure Video Processor (SVP) protocols and receive content via a conditional access (CA) gateway.

In another aspect of the present invention the player is configured to support Secure Video Processor (SVP) protocols.

In another aspect of the present invention the player is configured to receive CA gateway content from the host.

In another aspect of the present invention the player is configured to detect the presence or absence of an indicator on the recordable medium indicating that the item of content is pre-authorized for access by the player, and request, if the indicator is not detected on the recordable medium, authorization for the player to access the item of content.

In another aspect of the present invention the system further includes a location indicator of an authorization service center stored within the content license, where the player is configured to send the content license to the authorization service center at the location, and receive a modified content license from the authorization service center including an authorization for the player to access the item of content.

In another aspect of the present invention the location indicator includes a URL of the authorization service center.

In another aspect of the present invention the identification of the item of content is a mathematical function of at least a portion of the item of content.

In another aspect of the present invention the recordable medium identifier is unique to the recordable medium in accordance with a predefined statistical likelihood.

In another aspect of the present invention the recordable medium identifier is generated as part of a formatting process of the recordable medium.

In another aspect of the present invention the recordable medium identifier is stored on the recordable medium.

In another aspect of the present invention the player is configured to generate a comparison identification of the recordable medium in accordance with the predefined recordable medium identification generation algorithm and describing the at least one physical characteristic of the recordable medium, compare the recordable medium identification with the comparison identification, and validate the recordable medium if the recordable medium identification and the comparison identification are identical within a predefined tolerance.

In another aspect of the present invention the player is configured to prevent access to the recordable medium if the recordable medium identification and the comparison identification are not identical within the predefined tolerance.

In another aspect of the present invention the system further includes a certificate for the recordable medium, the certificate including the recordable medium identification and a recordable medium public key.

In another aspect of the present invention the recordable medium certificate includes a list of restrictions indicating permissible uses of the recordable medium.

In another aspect of the present invention the restrictions include any of the following restrictions the recordable medium does not allow local recording, the recordable medium permits local recording, and the recordable medium permits recording content from at least one specified content provider only.

In another aspect of the present invention the recordable medium certificate is signed with a signing key of the manufacturer of the recordable medium.

In another aspect of the present invention the player is configured to validate the recordable medium certificate signature with a public key of the authorized manufacturer or producer of the recordable medium.

In another aspect of the present invention the system further includes a certificate for the manufacturer of the recordable medium certificate stored on the recordable medium.

In another aspect of the present invention the system further includes a signed chain of certificates from the recordable medium manufacturer's certificate to a root certificate having a corresponding chain of signing keys

In another aspect of the present invention the chain of certificates is stored on the recordable medium.

In another aspect of the present invention any of the chain of certificates is signed with a recordable medium private key.

In another aspect of the present invention the player is configured to validate the chain of certificates with corresponding chain of public keys.

In another aspect of the present invention the recordable medium includes any of the following: a list of revoked devices, a software update for the player, a data update for the player, and a list of public keys of other devices for encrypting any items of content on the recordable medium or other recordable media for use with the other devices.

In another aspect of the present invention the secure content license includes a Content Segment License (CSL) corresponding to a specific segment of the unit of content, a Content User License (CUL) specifying user permissions with respect to the unit of content, and a Baseline Entitlement Control Message (BL-ECM) including an indication of a control word for decrypting the unit of content.

In another aspect of the present invention the system further includes a directory of data stored on the recordable medium, where the directory is signed with either of a signing key of an authorized manufacturer of the recordable medium where the content is pre-loaded onto the recordable medium, and a secure processor key of the player where the content is stored to the recordable medium by the player.

In another aspect of the present invention the player is configured to receive content from the host for recording onto the recordable medium, and to receive from the host a content restriction imposed by or on the host for preserving by the player.

In another aspect of the present invention the player is configured to permit playout of content received from the host to any of a plurality of hosts exclusively from the recordable medium where the content restriction indicates that content may be played out via a plurality of hosts.

In another aspect of the present invention the content is rendered exclusively accessible to at least one player in a domain of players, and is stored onto the recordable medium.

In another aspect of the present invention the player is configured to render the content exclusively accessible to the at least one player, and store the content onto the recordable medium.

In another aspect of the present invention the system further includes a list of players in the domain.

In another aspect of the present invention the player is configured to transmit a list of players in the domain to the host together with the content.

In another aspect of the present invention the host is configured to store a list of players in the domain at the host.

In another aspect of the present invention the system further includes a list of players in the domain generated by a user.

In another aspect of the present invention the system further includes a plurality of public keys corresponding to the list of players and stored on the recordable media of corresponding player IDs for selection by a user via either of a label affixed to the player and a user interface menu.

In another aspect of the present invention a plurality of public keys corresponding to the list of players is received from each of the players belonging to the domain.

In another aspect of the present invention the item of content is stored on the recordable medium where the content is received via broadcast, multicast or unicast, and where either of the recordable medium and the content are configured to allow playback of the content stored on the recordable medium by any player.

In another aspect of the present invention the content includes a regional restriction indicator specifying at least one region that is allowed to or disallowed from accessing the content, and where the player is configured to maintain a record of the regions to which it belongs and allow either of storage and playback of the content where the player belongs to the region specified in the regional restriction.

In another aspect of the present invention the regional restriction indicator specifies either of a geographic region and a logically defined region.

In another aspect of the present invention the content is stored on the recordable medium, and where either of the recordable medium and the content are configured to allow playback of the content stored on the recordable medium by any player and to prevent subsequent storage of the content onto another device.

In another aspect of the present invention the player is configured to permit a personal copy of the content to be stored to recordable medium and distributed only to an SVP-compliant device for immediate viewing thereat, and where the SVP-compliant device is configured to prevent local storing of the content or output of the content to any other device.

In another aspect of the present invention the content license includes data required for an SVP-compliant content license and BL-ECM.

In another aspect of the present invention the recordable medium is configured to permit storage thereto of content originating exclusively from a predefined source.

In another aspect of the present invention the item of content is stored on the recordable medium in advance of the player first accessing the content, and where the recordable medium is configured to permit storage thereto of content originating exclusively from the source of the stored content.

In another aspect of the present invention the system further includes a password associated with the content, and where either of the player and the host are configured to receive and validate the password prior to permitting access to the content.

In another aspect of the present invention the item of content is stored on the recordable medium in advance of the player first accessing the content, where the content is non-pre-authorized content, and where the player is configured to decrypt with the password received from an authorization center a BL-ECM including a control word for decrypting the content.

In another aspect of the present invention the player is configured to disallow access to the content if a current date received from an authorized time source is later than a final expiration date specified in the content license.

In another aspect of the present invention the player is configured to permit access to the content if a current date received from an authorized time source is not later than a final expiration date specified in the content license.

In another aspect of the present invention a system is provided for validating content stored on a storage medium, the system including a content storage medium, and a player configured to validate the content storage medium by accessing a certificate stored on a content storage medium, determining that an identifier in the certificate matches the results of an algorithm applied to physical properties of the content storage medium, determining that the certificate is properly signed, and if the content storage medium is valid, validating content stored on the content storage medium by accessing a content license associated with an item of content stored on the content storage medium, the content license having a plurality of components, each component signed by a signing entity, determining that each of the components is properly signed, and decrypting a control word stored as part of the content license.

In another aspect of the present invention a system is provided for writing locally recorded content to a storage medium, the system including a unit of content, a host configured to receive a broadcast, multicast or unicast stream containing the content and an associated content license (CL) including a content binding vector (CBV), and a player configured to validate the CL, and write the content and the CL to a storage medium if the CL is valid.

In another aspect of the present invention the host is configured to initiate a request to the player to write the content to the storage medium, and send the CL to the player, the player is configured to notify the host that it may send the content to the player if the CL is valid, and the host is configured to send the content to the player.

In another aspect of the present invention a system is provided for writing locally recorded content to a storage medium under conditional access (CA) control, the system including a host configured to receive a broadcast stream containing content and an associated content license (CL) including a placeholder for a content binding vector (CBV), and a player configured to generate a CBV for the content, where the host is configured to replace the placeholder with the generated CBV, and where the player is configured to write the content and the CL to the storage medium.

In another aspect of the present invention the host acts as a CA gateway and sends the CL to the player, where the player sends the generated CBV to the CA gateway, and where the host sends the CL, including the generated CBV, to the player.

In another aspect of the present invention a system is provided for playing content stored on a storage medium, the system including a storage medium, a player configured to access the storage medium, and a host configured to receive a query for a content list stored on the storage medium and send a request to the player to play a content item selected from the content list, where the player is configured to determine whether the content item is pre-authorized, validate a content license (CL) associated with the content item if the content item is pre-authorized, and play the content item if the content item is pre-authorized.

In another aspect of the present invention a system is provided for playing non-pre-authorized content stored on a storage medium, the system including a player, and a host configured to send a content license (CL) of a non-pre-authorized content item to an authorization service center, provide payment information to the authorization service center, receive an updated CL with content decryption information from the authorization service center, and provide the CL to the player, where the player is configured to validate the CL and provide access to the content if the CL is valid.

In another aspect of the present invention a system is provided for writing content stored on a storage medium, the system including a storage medium, and a player configured to access the storage medium and receive a request from a requestor to provide content stored on a storage medium for copying by the requester, validate a content license (CL) associated with the requested content, determine from the validated CL if the requestor is permitted to write the requested content, and provide the requested content to the requestor for writing thereby.

In another aspect of the present invention a system is provided for writing content to a storage medium without a content license (CL) and reading content therefrom, the system including a first encryption key, a second encryption key, and an item of content encrypted with the second encryption key, where the second encryption key is encrypted with the first encryption key, and where the encrypted content and the second encryption key are stored onto a storage medium.

In another aspect of the present invention the first encryption key is stored in a player configured to perform the encryption.

In another aspect of the present invention the player is configured to decrypt the second encryption key with the first encryption key if no CL is detected for the content, decrypt the content with the decrypted first encryption key, and provide the decrypted content to a requestor.

In another aspect of the present invention a system is provided for generating a content license (CL), the system including a) a signed Content Segment License (CSL) corresponding to a specific segment of the unit of content, b) a signed Content User License (CUL) specifying user permissions with respect to the unit of content, c) a signed and encrypted Baseline Entitlement Control Message (BL-ECM) including an indication of a control word for decrypting the unit of content, and d) a CL incorporating the CSL, CUL, and BL-ECM, where the CL is encrypted with a public key associated with a storage medium.

In another aspect of the present invention the CSL is provided by an owner of the content.

In another aspect of the present invention the CUL is provided by a conditional access (CA) gateway.

In another aspect of the present invention the BL-ECM is provided by an encryptor of the content.

In another aspect of the present invention the CSL includes any of a CSL ID, a content ID, a content link, a content provider ID, an authorization service center ID, an authorization service center location, and a group authorizer public key.

In another aspect of the present invention the CUL includes any of a CSL ID, the public key associated with the storage medium, and a domain list.

In another aspect of the present invention the BL-ECM includes any of a CSL ID, an index lining the BL-ECM a corresponding location in the content, and a control word used to encrypt the content.

In another aspect of the present invention a system is provided for creating a Content Binding Vector (CBV) for a content block, the system including a content block divided into at least one content mini block, a digital signature generated for each of the content mini blocks, and a CBV for the content block, the CBV formed by combining the digital signatures of each of the content mini blocks in the content block.

In another aspect of the present invention system the content block includes an entropy encoded MEPG video bitstream.

In another aspect of the present invention system each of the digital signatures includes a set of hash bits for each of the content mini blocks.

In another aspect of the present invention each of the digital signatures includes a set of hash bits calculated using a one-way hash function.

In another aspect of the present invention the CBV includes a list of the digital signatures.

In another aspect of the present invention the list includes a concatenation of the digital signatures.

In another aspect of the present invention the list is asymmetrically signed.

In another aspect of the present invention the list is asymmetrically signed using a predefined field dedicated for use as the asymmetric signature.

In another aspect of the present invention the asymmetric signature is generated using a redundancy string that is a function of the content mini block.

In another aspect of the present invention the asymmetric signature is generated corresponding to the entire CBV.

In another aspect of the present invention the asymmetric signature is generated from a plurality of asymmetric signatures, where each of the plurality of asymmetric signatures corresponds to a different group of bits within the CBV.

In another aspect of the present invention any of the content mini blocks is protected by appending an error detection code (EDC) to any of the content mini blocks, thereby forming an error detectable block.

In another aspect of the present invention the system further includes a player configured to identify an error detectable block as a failed error detectable block where the error detectable block includes an error in its content bits as determined by applying a predefined CBV verification algorithm.

In another aspect of the present invention the EDC is constructed using the TCP/IP 1-complement checksum technique.

In another aspect of the present invention the EDC is constructed using the CCITT standard used for checksums.

In another aspect of the present invention the error detectable block is appended to the CBV, thereby forming a storable block.

In another aspect of the present invention a system is provided for validating content, the system including means for assessing the invalidity of a content signature at a first resolution relative to a first invalidity threshold, means for restricting access to the content if the first resolution invalidity exceeds the first invalidity threshold, means for assessing the invalidity of the content signature at a second resolution relative to a second invalidity threshold, and means for restricting access to the content if the second resolution invalidity exceeds the second invalidity threshold.

In another aspect of the present invention a system is provided for validating content, the system including means for validating the signature of a CBV of a content block stored in a storable block means for incrementing an invalid signature count if the signature is invalid, means for restricting access to the content block if the invalid signature count exceeds an invalidity threshold, if the invalid signature count does not exceed the invalidity threshold means for breaking the storable block into a plurality of content mini blocks and their corresponding error detection codes (EDC) and hash bits, means for validating the EDCs corresponding to each of the content mini blocks, means for incrementing an invalid EDC count if the EDC is invalid, means for restricting access to the content block if the invalid EDC count exceeds an invalid EDC count threshold, if the invalid EDC count does not exceed the invalid EDC count threshold means for validating the hash bits corresponding to each of the content mini blocks, means for incrementing an invalid hash bits count if the hash bits are invalid, means for restricting access to the content block if the invalid hash bits count exceeds an invalid hash bits threshold.

In another aspect of the present invention the means for validating the EDC includes means for reconstructing the EDC from the content mini block in the manner in which the EDC was constructed, and means for comparing the reconstructed EDC to the EDC, where validity of the EDC is established where the EDC matches the reconstructed EDC.

In another aspect of the present invention the means for validating the hash bits includes means for reconstructing the hash bits from the content mini block in the manner in which the hash bits were constructed, and means for comparing the reconstructed hash bits to the hash bits, where validity of the hash bits is established where the hash bits match the reconstructed hash bits.

### GLOSSARY OF TERMS

Authorizer:

The gateway that passes the content to the RMS Player. An authorizer can assign RMS Players to Groups (e.g., subscribers to service X) which share a public key/private key giving them access to some content.
   BL-ECM:
Baseline ECM (term per SVP)—part of the CL containing encrypted CWs.
   CA:
Conditional Access.
   CE:
Consumer Electronics manufacturer (e.g., an STB manufacturer) or CE device.
   Conditional Access:
The security technology used to control the access to broadcast information, including video and audio, interactive services, or data. Access is restricted to authorized subscribers through the transmission of encrypted signals and the programmable regulation of their decryption by a system such as viewing cards.
   Content Binding Vector (CBV):
A specific algorithm type for binding the content to the CL
   Content License (CL):
Specifies the permits associated with a particular piece of content and contains the keys required for decrypting the content. Cryptographically linked to the content. Made up of CSL, CUL and BL-ECM
   Content Link:
A generic name for the method of binding content to the CL
   Content Segment License (CSL):
Part of the CL bound to the content
   Content User License (CUL):
Part of the CL specifying user entitlements
   Control Word (CW):
The key used to encrypt and/or decrypt content, which is typically encrypted within the CL. A single title may have more than one Control Word, for instance, each time the Content Link changes.
   Digital Rights Management (DRM):
A digital means of protecting content during transfer.
   ECM:
Entitlement control message. A conditional access packet that contains information needed to determine the control word that decrypts encrypted content.
   Final Expiration Date (FED):
A date after which no rights are granted to the user, regardless of what rights may be granted to that user prior to that date.
   Gateway:
A secure device which is able to transfer content between two security methods by translating the restrictions of one to the format of the other. Specifically, the CA-RMS gateway may be the PVR, while the RMS-SVP gateway may be the RMS Player.
   Host:
The device to which the RMS Player is linked. Examples of appropriate devices include PVRs and digital TVs.
   Keys:
Public/Private Keys used in the security system of the RMS to access the CL, to validate a host etc. (The term Control Word is used to distinguish content encryption keys.)
   Owner:
Content owner or original source.
   PVR:
Personal Video Recorder.
   Secure RMS Processor (SRP):
RMS Player's secure processor will implement the cryptographic functions defined in this document
   Secure Video Processor (SVP):
Chip embedded in various devices used to enforce copy protection.
   RMS:
Removable Mass Storage.
   RMS Certificate:
A secure certificate containing the RMS ID which can be validated by the SRP
   RMS ID:
An identifier generated for an RMS that is based on physical characteristics of the RMS.
   RMS Manufacturer or Producer:
The authorized body responsible for the secure production of the RMS media, including formatting, generation of the RMS ID, writing of data including the RMS Certificate, other certificates and other data, and optional pre-loading of content.
   RMS Player:
A secure player designed to play RMS media, for internal integration in a PVR or external connection to CE devices.
   RMS Pub:
RMS Public Key, calculated from RMS ID.
   Safe Distance Criteria:
Represents the degree of distortion by which content may be modified and yet retain its association with its corresponding CBV.
   Smart Card:
A programmable card. A conditional access security device in the subscriber's home, it receives and records entitlements from the headend and checks these against the incoming program information in the entitlement control messages. If the subscriber is authorized to view the current program, the smart card provides the control word to STB. Also called a viewing card.
   SRP:
Secure RMS Processor
   STB:
Set Top Box. A receiver unit, with an internal decoder, that is connected to the television set. It receives and demultiplexes the incoming signal and decrypts it when provided a control word.
   SVP:
Secure Video Processor.
   Writing:
The process of creating a digital copy of a content item on a storage device, such as an RMS or a hard disk. This process may be either a “copy,” where the original copy of the content is left on the original medium and a second copy is created at a different location; or a “move,” where the original copy is removed to a different location. Both terms “copy” and “move” are used in DRM terminology. Unless otherwise specified herein, the term “write” may refer to “copying,” “moving,” or both
   XTV:
A PVR commercially available from NDS Limited.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a multimedia storage and access system, constructed and operative in accordance with a preferred embodiment of the present invention;

FIG. 2 is a simplified pictorial illustration of a player and host configuration, constructed and operative in accordance with a preferred embodiment of the present invention;

FIG. 3 is a simplified pictorial illustration of a player and host software configuration, constructed and operative in accordance with a preferred embodiment of the present invention;

FIG. 4A is a simplified flowchart illustration of an exemplary method of RMS preparation, operative in accordance with a preferred embodiment of the present invention;

FIG. 4B is a simplified flowchart illustration of an exemplary method of operation of a multimedia storage and access system, operative in accordance with a preferred embodiment of the present invention;

FIG. 5 is a simplified flowchart illustration of an exemplary method of writing locally recorded content to an RMS, operative in accordance with a preferred embodiment of the present invention;

FIG. 6 is a simplified flowchart illustration of an exemplary method of writing locally recorded content to an RMS under CA control, operative in accordance with a preferred embodiment of the present invention;

FIG. 7 is a simplified flowchart illustration of an exemplary method of playing content stored on an RMS, operative in accordance with a preferred embodiment of the present invention;

FIG. 8 is a simplified flowchart illustration of an exemplary method of playing non-pre-authorized content stored on an RMS, operative in accordance with a preferred embodiment of the present invention;

FIG. 9 is a simplified flowchart illustration of an exemplary method of writing content stored on an RMS, operative in accordance with a preferred embodiment of the present invention;

FIG. 10 is a simplified flowchart illustration of a method for preparing storage media, operative in accordance with a preferred embodiment of the present invention;

FIG. 11 is a simplified flowchart illustration of a method for writing content to an RMS without a CL and reading content therefrom, operative in accordance with a preferred embodiment of the present invention;

FIG. 12 is a simplified flowchart illustration of a method for writing content to an RMS with a CL and reading content therefrom, operative in accordance with a preferred embodiment of the present invention;

FIG. 13 is a simplified flowchart illustration of a method for validating an RMS, operative in accordance with a preferred embodiment of the present invention;

FIG. 14 is a simplified flowchart illustration of an exemplary method for generating a content license (CL), operative in accordance with a preferred embodiment of the present invention;

FIG. 15 is a simplified conceptual illustration of a certificate infrastructure, constructed and operative in accordance with a preferred embodiment of the present invention;

FIGS. 16A and 16B are simplified block flow diagrams of a method of creating a Content Binding Vector (CBV), operative in accordance with a preferred embodiment of the present invention; and

FIGS. 17A and 17B, taken together, is a simplified flow chart illustration of a method for validating content, operative in accordance with a preferred embodiment of the present invention.

### DETAILED DESCRIPTION OF PREFERRED EMBODIMENTS

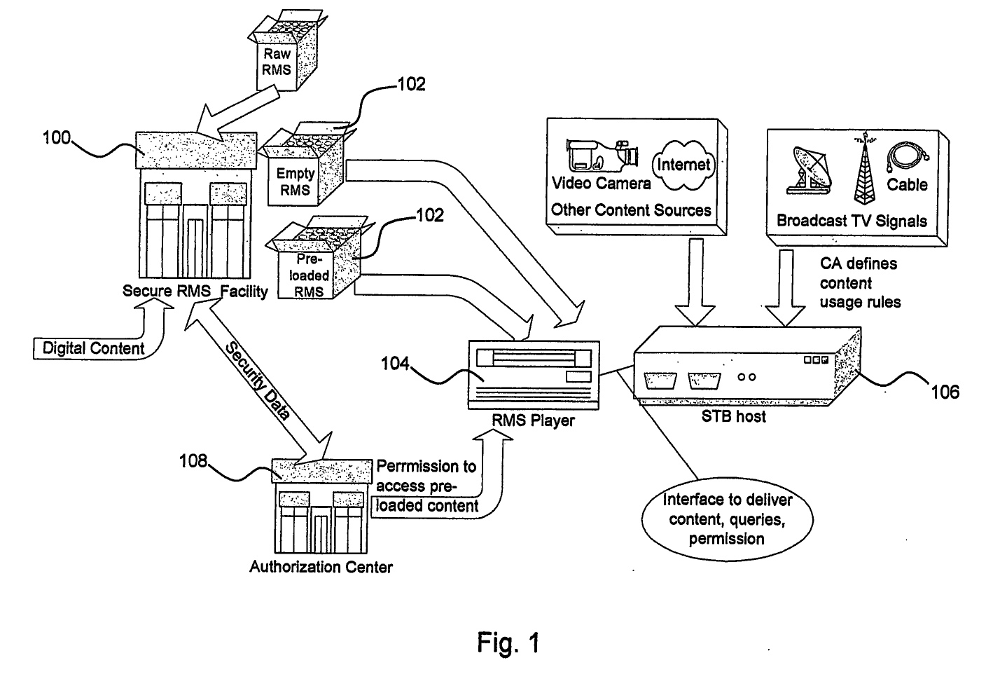

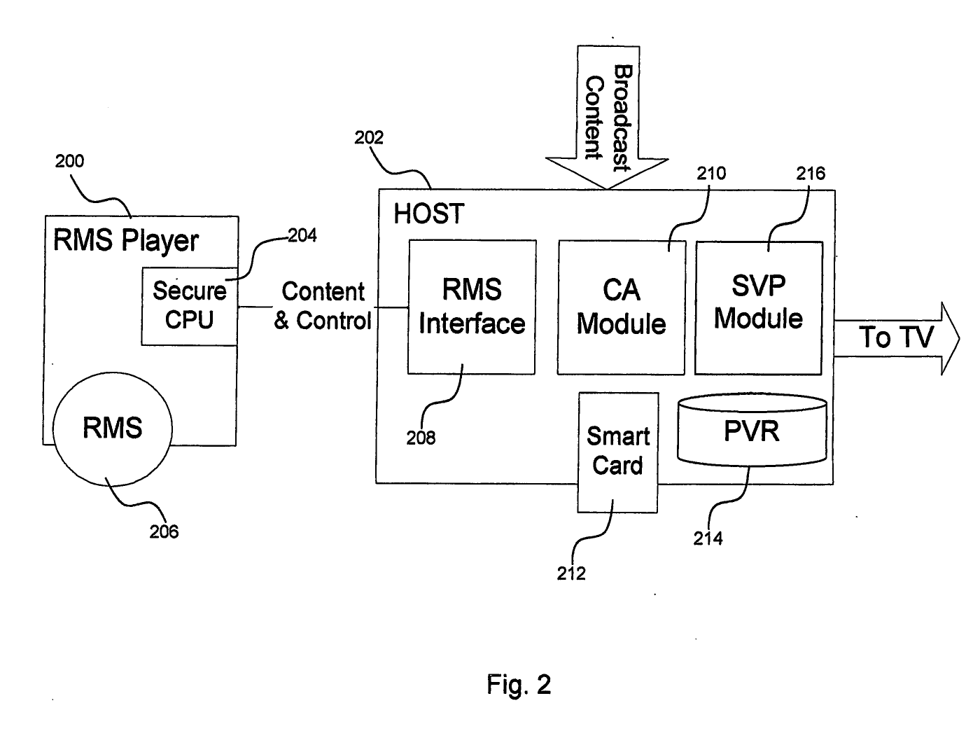

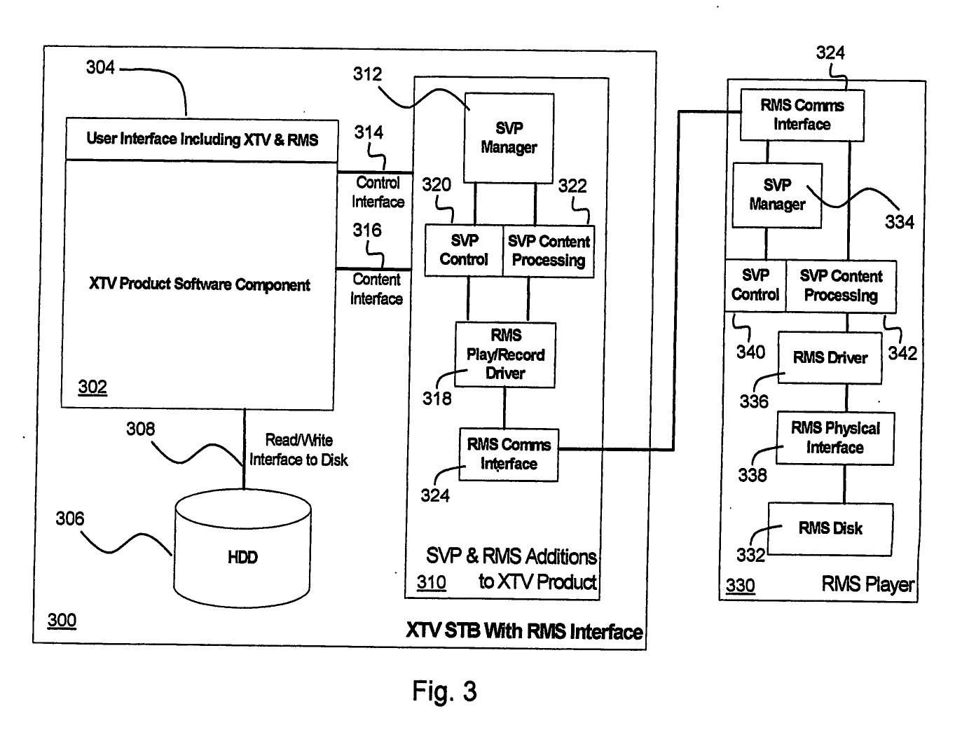

Reference is now made to FIG. 1, which is a simplified pictorial illustration of a multimedia storage and access system, constructed and operative in accordance with a preferred embodiment of the present invention. In the system of FIG. 1, a storage media processing facility 100, hereinafter referred to as an RMS Manufacturer, prepares storage media 102, hereinafter also referred to as removable mass storage (RMS), for use with a player 104, such as storage media that is described in U.S. Patent Application No. U.S. 2003174594, entitled “Method for tracking data in an optical storage medium,” PCT Patent Publication No. WO03077240 entitled “Method and apparatus for retrieving information from a 3d storage medium,” PCT Patent Publication No. WO03070689 entitled “Polymer bound donor-acceptor-donor compounds and their use in a 3 dimensional optical memory,” PCT Patent Publication No. WO0173779 entitled “Three-dimensional optical memory,” and Canadian Patent No. CA2404505 entitled “Three-dimensional optical memory,” all incorporated herein by reference. Player 104 is shown in functional cooperation with a host 106, such as a set-top box (STB), which may provide conditional access in accordance with conventional techniques to incoming multimedia content, such as from cable, satellite, or broadcast television, internet and other unicast or multicast sources, or from video camera or other known sources capable of providing multimedia content to host 106. A preferred player and host configuration is described in greater detail hereinbelow with reference to FIGS. 2 and 3. An Authorization Service Center 108 exchanges security information with processing facility 100, such as to validate storage media 102, and provides permissions to player 104, such as for allowing pre-loaded content on storage media 102 to be played on player 104.

Reference is now made to FIG. 2, which is a simplified pictorial illustration of a player and host configuration, constructed and operative in accordance with a preferred embodiment of the present invention. In the system of FIG. 2 a player 200 is shown in functional cooperation with a host 202. Player 200 preferably includes a central processing unit (CPU), herein referred to as a Secure RMS Processor (SRP) 204, for operating player 200 and an associated storage device, such as an RMS 206. SRP 204 preferably includes an SRP ID uniquely identifying player 200, as well as a secret key, a root certificate authority public key, a public/private key pair for encryption, and one or more optional global SRP keys as is described hereinbelow. Host 202 preferably includes an interface 208 for communicating with player 200, a conditional access (CA) module 210 and smart card 212 for controlling access to content received by host 202 in accordance with conventional CA techniques, and a Personal Video Recorder (PVR) 214 for storing content, described in greater detail hereinbelow with reference to FIG. 3. Host 202 may be an STB-PVR system such as the XTV™ system, commercially available from NDS Limited. It is appreciated that any of the elements shown may be housed together within a single device or may be housed within separate, cooperating devices. Host 202 is preferably connectable to a television or other known output device and able to receive broadcast TV signals, tune to a desired program, display TV content, run broadcast TV conditional access, run an Electronic Program Guide (EPG) application, and optionally run interactive applications.

Host 202 preferably interacts with player 200 whenever content is to be recorded on RMS 206 or played back from RMS 206. The interactions typically include: querying player 200, such as to identify content stored on RMS 206, to receive permission for recording or playing out content to/from RMS 206, and to determine the space available for recording on RMS 206; instructing player 200 to record content to RMS 206 with access permission information; and instructing player 200 to play content stored on RMS 206 based on valid access permissions.

Host 202 may be configured to receive content via a conditional access gateway, such as may be provided by conditional access (CA) module 210 and smart card 212 in accordance with conventional techniques, which will supplement or replace CA data with RMS permissions. Depending on the permissions, the content when transferred from host 202 to player 200 may be transferred as-is and locally super-encrypted in player 200 using conventional techniques, super-encrypted before transfer, or decrypted and locally re-encrypted before transfer.

Host 202 may include a digital rights management (DRM) interface, in accordance with one of the developing standards or proposed standards, such as a Secure Video Processor (SVP) 216, commercially available from NDS Limited, for decrypting and decompressing video. Content received via a conditional access gateway may have its broadcast CA information replaced with SVP content protection data. Alternatively, Host 202 may receive content directly in DRM format, without requiring a CA Gateway. SVP 216 may also transfer data to another device, depending on the permissions in the SVP CP data. If host 202 includes SVP 216, then content preferably goes through CA gateway processing in accordance with conventional techniques in the host 202 before it is transferred to the player 200 and is returned to host 202 via SVP protocols. These and other aspects of SVP 216 are described in greater detail in a published, publicly-available document entitled “NDS Approach to Content Protection—The Secure Video Processor Concept,” NDS Doc. No. WP-R063, commercially available from NDS Limited, the disclosure of which is hereby incorporated herein by reference.

Reference is now made to FIG. 3, which is a simplified pictorial illustration of a player and host software configuration, constructed and operative in accordance with a preferred embodiment of the present invention. The system of FIG. 3 is shown integrating RMS Player functionality into an STB 300, such as an STB-PVR system incorporating elements of the XTV™ system, commercially available from NDS Limited, One London Road, Staines, Middlesex TW18 4EX United Kingdom, and having additional components for communication between the XTV™ STB and an RMS player as described herein. STB 300 may optionally include components for use with an SVP-based architecture.

In FIG. 3, STB 300 is shown in communication with an RMS player 330, which, in accordance with conventional techniques, may be built into STB 300 or may be external to STB 300. STB 300 typically includes the requisite hardware and a Product Software Component 302 including software required to receive broadcast television, to use conditional access to determine whether access is permitted, and to decrypt and decode content when authorized. STB 300 also typically includes a user interface 304 allowing the user to view programming scheduled for broadcast, where such information is available in the broadcast signal, to tune to live signals, and to perform other related interactions, such as to respond to conditional access requests and notifications, and to configure the behavior of STB 300, all in accordance with conventional techniques. The PVR element in STB 300, such as PVR 214 (FIG. 2), preferably includes an interface for selecting a currently-displayed program or a future program for recording. PVR 214 preferably records programs along with any associated program metadata and any additional data required by PVR functions (such as NDS's RASP™ data), plays the recorded content, manages recorded content, and performs any other functions of known PVRs. RASP™ is commercially available from NDS Limited and is described in PCT Published Patent Application WO 01/35669 of NDS Limited, the disclosure of which is hereby incorporated herein by reference.

XTV™ extensions of user interface 304 typically include the ability to access programming previously recorded on a storage medium 306, such as a hard disk drive, to request the recording of new content, and additional functionality known for use with XTV™. Product Software Component 302 typically controls storage 306 via a storage interface 308 through which content is read and written. User interface 304 is preferably enhanced to allow the user to transfer content to and from player 330 for storage to and/or playback from its RMS, such as RMS 332, to view what content is available on RMS 332, and to otherwise interact with RMS 332.

STB 300 is shown having an add-on module 310 including components for use with SVP and RMS systems. Module 310 typically includes an SVP manager 312, typically implemented in software and responsible for routing user requests to access, copy, or move content among SVP hardware elements, determining whether a request can be met, and managing the necessary interactions across a Control Interface 314 and a Content Interface 316 to Product Software Component 302 and to a RMS Play/Record Driver 318 when RMS functionality is required. An SVP Control component 320, typically implemented in hardware, is responsible for secure processing of user requests, and an SVP Content Processing component 322, typically implemented in hardware, is responsible for encryption and decryption of content in accordance with the instructions provided by SVP Control 320.

SVP Manager 312 preferably handles RMS functionality in a manner similar to the SVP. Where no SVP is present, SVP Manager 312 will preferably handle only RMS management functions. SVP Manager 312 interfaces with player 330 via an RMS Communications interface 324. RMS Play/Record Driver 318 is responsible for processing high-level commands and driving the hardware level to deliver control and content to RMS Communications interface 324.

RMS player 330 typically receives information via the RMS Communications interface 324. Requests to access, copy, or move content are handled by its SVP manager 334 in the same way as they are handled in SIB 300, except that SVP Manager 334 in RMS Player 330 preferably uses RMS security as described herein, such as by employing an RMS Secure Processor, in addition to the SVP control, to determine suitable behavior, such as permitting or denying requests to access, copy or move content. An RMS driver 336 is used to drive the RMS player hardware. An RMS Physical interface 338 preferably includes motors, lasers and/or other means used to turn RMS 332 or position the read/write devices over RMS 332 as necessary, and to read and write content to/from RMS 332. RMS 332 represents the actual RMS medium, which may be a disk or any other known data storage medium.

Where there is an SVP in RMS Player 330 and in SIB 300, and SVP control has been invoked in accordance with a known conditional access handoff from the Product Software Component 302, an SVP Control component 340 and an SVP Content Processing component 342 are preferably employed by RMS player 330.

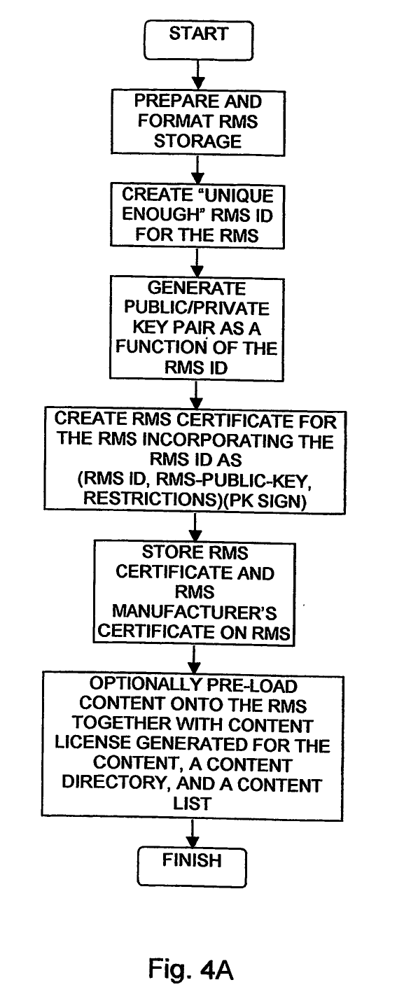

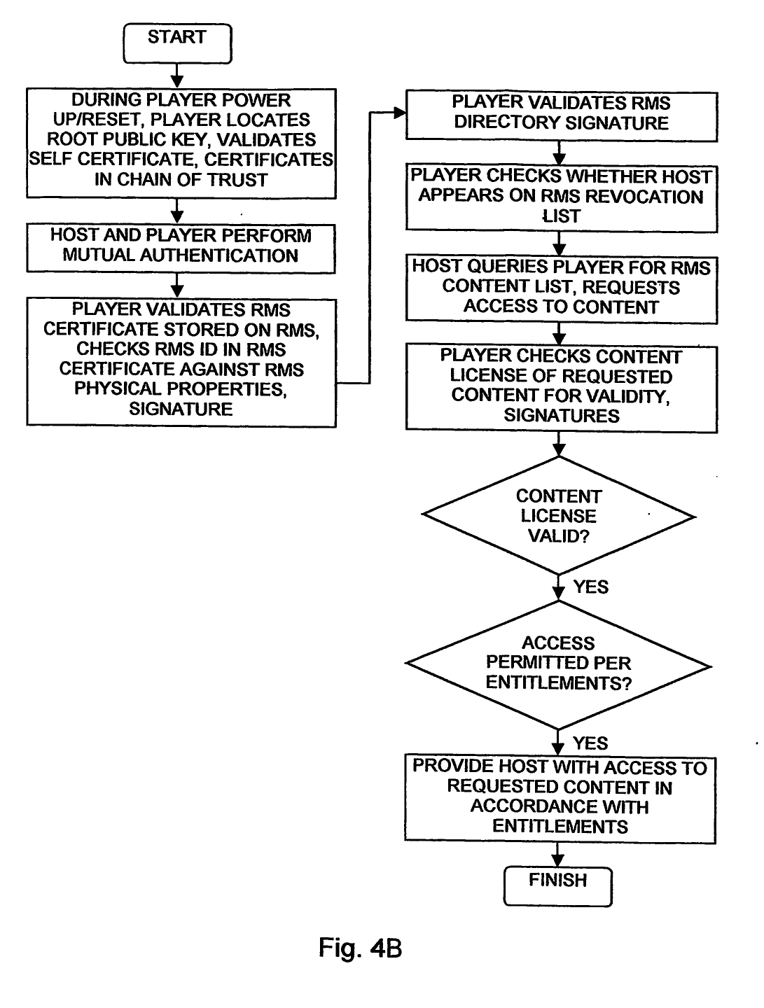

Reference is now made to FIG. 4A, which is a simplified flowchart illustration of an exemplary method of RMS preparation, operative in accordance with a preferred embodiment of the present invention. In the method of FIG. 4A, RMS storage is prepared and formatted in accordance with conventional techniques in a manner appropriate to the medium. For example, a File System data may be created for a hard disk. An arbitrary RMS ID is preferably created for the RMS, such as where a “unique enough” ID is generated for an RMS based on physical characteristics of the RMS media, and is stored on the RMS. The RMS ID may be created before, during, or after the formatting process. Suitable physical characteristics for use typically depend on the particular media, such as is described in U.S. Pat. No. 5,988,500 to Litman and in PCT Published Patent Application WO 99/38162 assigned to NDS Limited, the disclosures of which are hereby incorporated herein by reference. Persons skilled in the art will appreciate that techniques suitable to the particular media should be used. “Unique enough” may be understood as an identifier that is unique in accordance with a predefined statistical likelihood, such as no more than two RMSs per million sharing the same RMS ID.

A public and private key pair is preferably generated as a function of the RMS ID using conventional key generation techniques. An RMS Certificate is then preferably created for the RMS incorporating the RMS ID as follows:
RMS Certificate=(RMS ID, RMS-Public-Key, restrictions)(PK sign)
where the RMS public key is preferably provided by an RMS manufacturer or producer (hereinafter simply “RMS manufacturer”) that is authorized by an authorizing body to perform RMS formatting, producing the RMS ID, and writing data to the RMS, the data including, but not limited to, content. The public key signature preferably uses the RMS Manufacturer's signing key. The RMS Manucturer's certificate, also preferably provided by the RMS manufacturer, is also preferably stored on the RMS and signed using the signing key of the root certificate authority or other designated authority issuing this certificate. If another designated authority has been used, then a chain of certificates to be used to validate the designated authority is also preferably written to the RMS in addition to the RMS manufacturer's certificate. The RMS Certificate may include restrictions indicating how the RMS may be used. For example, an RMS Certificate might include none or any combination of the following restrictions:
The RMS does not allow local recording—only pre-loaded content is allowed;
The RMS permits local recording;
The RMS permits recording content from specified content provider(s) only.

Content, such as multimedia files, may be pre-loaded onto the RMS together with a content license (CL) which is generated for the content and which typically includes a Content Segment License (CSL) which relates to a specific segment of the content, a Content User License (CUL) which specifies user permissions with respect to the content, and a Baseline Entitlement Control Message (BL-ECM) which includes information needed to determine the control word that decrypts encrypted content. Preferred methods for creating the content license are described in greater detail hereinbelow.

A directory indicating the physical and/or logical locations of content stored on the RMS may be created and stored on the RMS. The directory format may be any known format, such as the FAT commonly used in Consumer Electronics (CE) device hard disks. The directory also preferably indicates the location of RMS control data elements described herein, such as the RMS ID, RMS Public Key, content licenses and certificates. Prior to storing the directory, it is preferably signed, such as by the RMS manufacturer's private key for pre-loaded content, or the SRP in the case of locally-written content.

A content list is also typically written to the RMS, including a description of the content. The content list preferably contains content metadata, such as the content title, actors, genre, and other information for use by the host. For content recorded in XTV™ format, the metadata preferably includes known XTV™ Metadata, such as RASP indexing, PECMs, etc. Entries in the content list are typically associated with entries in the directory, such as by storing a directory entry ID together with the relevant item in the content list.

Other information may also be written to the RMS, such as a revocation list which identifies unauthorized players or hosts, a list of SRP IDs and associated public keys, and time source information for Final Expiration Date (FED) checking.

Reference is now made to FIG. 4B, which is a simplified flowchart illustration of an exemplary method of operation of a multimedia storage and access system, operative in accordance with a preferred embodiment of the present invention. In the method of FIG. 4B, when the player is powered up or reset, the player preferably locates a root public key and validates its self certificate and any other certificates in the chain of trust where present. The root public key may be stored internally within the player or may be retrieved from an external source using techniques such as described in the SVP protocol, NDS Doc. No. WP-R063, referred to hereinabove. If a host is present, the host and player preferably mutually authenticate each other using their certificates in accordance with conventional methods, such as those described in the X.509 standard, and establish a secure channel using conventional techniques.

When the RMS is inserted into the player, the player preferably accesses the RMS certificate stored on the RMS and validates the RMS certificate by checking that the RMS ID in the RMS certificate matches the physical properties of the RMS by creating a comparison RMS ID using the same algorithm used to create the RMS ID in the RMS certificate, and by checking whether the RMS certificate is properly signed by the RMS manufacturer's signing key by using the public key in the RMS manufacturer's certificate stored on the RMS and so on thru the chain of trust, if any, stored on the RMS. The player likewise preferably accesses and validates the RMS directory signature and checks whether the host appears on a revocation list stored on the RMS.

Once the RMS has been inserted into the player and validated, the host may query the player to see if a content list is stored on the RMS. If a content list is present, the player may deliver the content list to the host which may then request access to any content item from the content list, preferably indicating whether the access request is for playback or writing. The player then checks the content license for the requested content item to determine whether or not access should be permitted. For example, the signatures of the CSL, CUL, and BL-ECM may be checked for validity against the public key of each corresponding signing entity, which may vary as will be described hereinbelow. The BL-ECM containing the control words needed for content decryption is itself preferably encrypted using a key, the nature of which may vary in accordance with different modes of operation as described hereinbelow. If the player does not have permission to use this content, it will not have the correct key for decryption of the BL-ECM. The RMS public key stored on the RMS in the RMS certificate may also be checked for validity, and the player's SRP-ID may be checked against a list of SRP IDs stored on the RMS. Any entitlements indicated by the content license may be checked to determine if the requested usage is permitted. Once the content license has been checked, the player preferably returns an appropriate response to the host.

Once an RMS has been inserted into a player and the initial verification procedures described hereinabove have been performed, a variety of operations may be performed. These include reading content from the RMS or supplying content to the RMS, such as for writing locally recorded content to the RMS, writing content received under conditional access control, and playing content via the host. Each of these operations is described in greater detail hereinbelow.

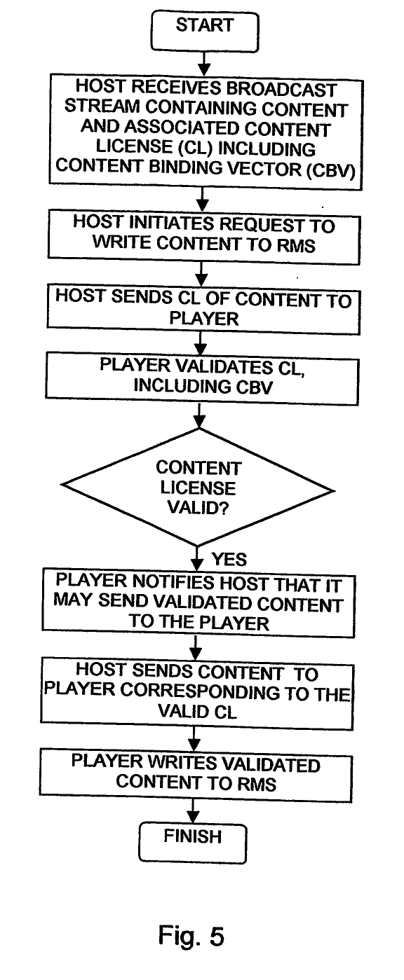

Reference is now made to FIG. 5, which is a simplified flowchart illustration of an exemplary method of writing locally recorded content to an RMS, operative in accordance with a preferred embodiment of the present invention. In the method of FIG. 5, the host receives a broadcast stream containing content, typically from a cable or satellite transmission source, together with one or more associated content licenses (CL) including content links such as content binding vectors (CBV). Where content is received encrypted under conditional access protocols, it preferably undergoes conventional conditional access processing prior to transfer to the RMS control. The host then initiates a request to write content to the RMS. The host then sends a CL associated with the content, including a CSL, CUL, and BL-ECM, to the player. Where the content is divided into segments, each segment having its own CL, the host preferably sends each CL together with or preceding its related segment. The player SRP then validates the CL as described above and preferably maintains the validated CL in memory. If the CL is valid, the player then preferably notifies the host that it may send the content to the player.

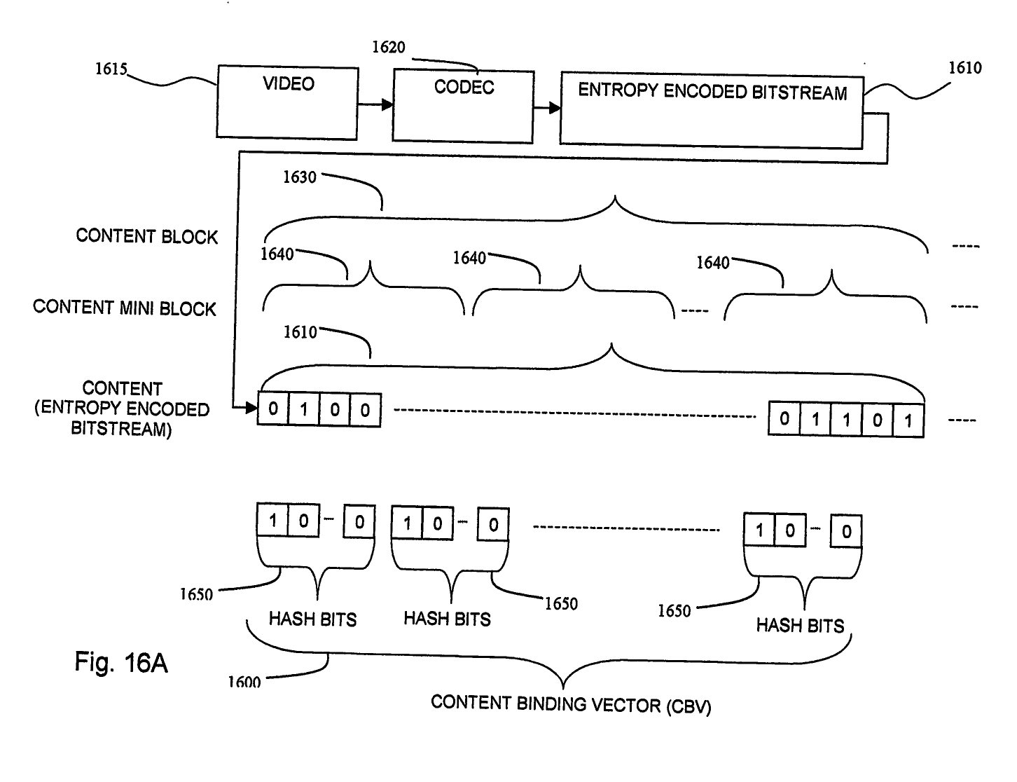

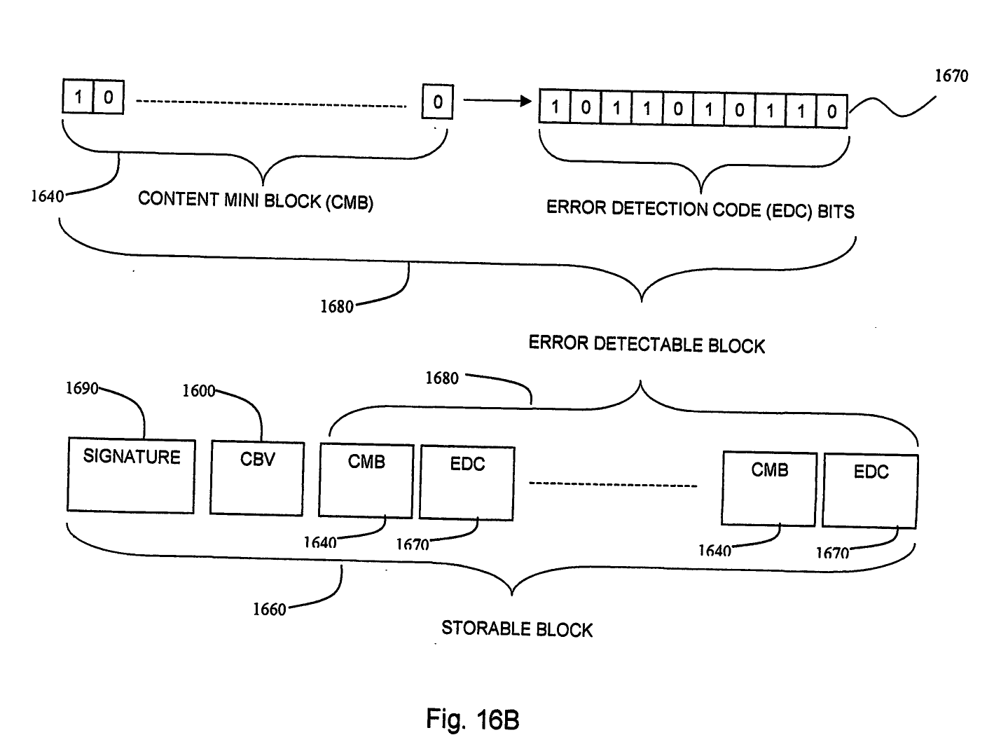

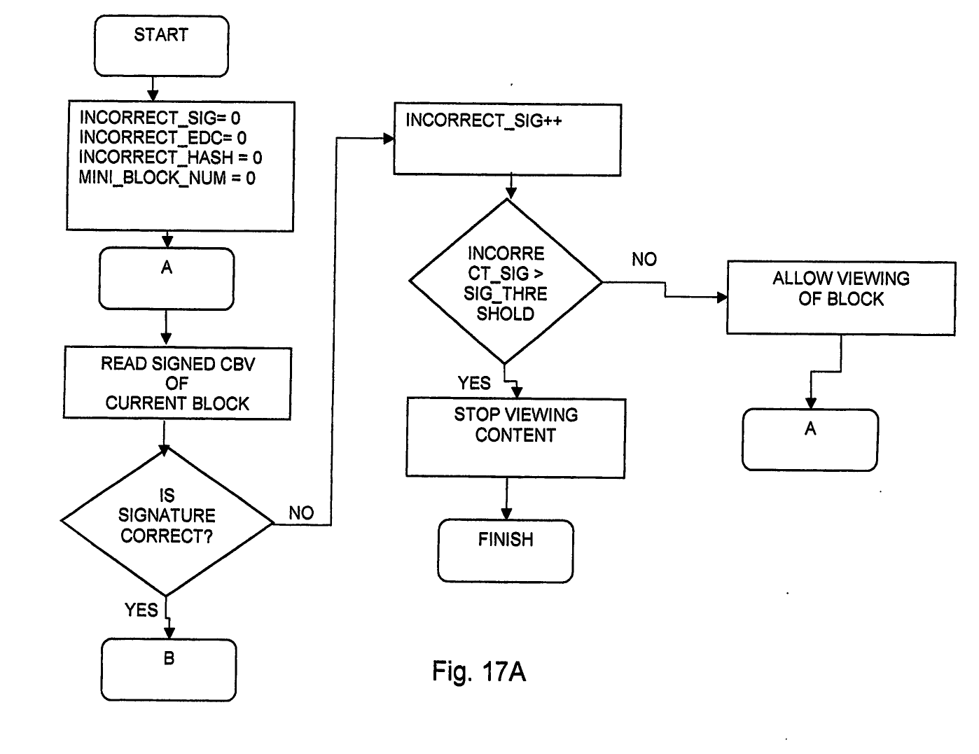

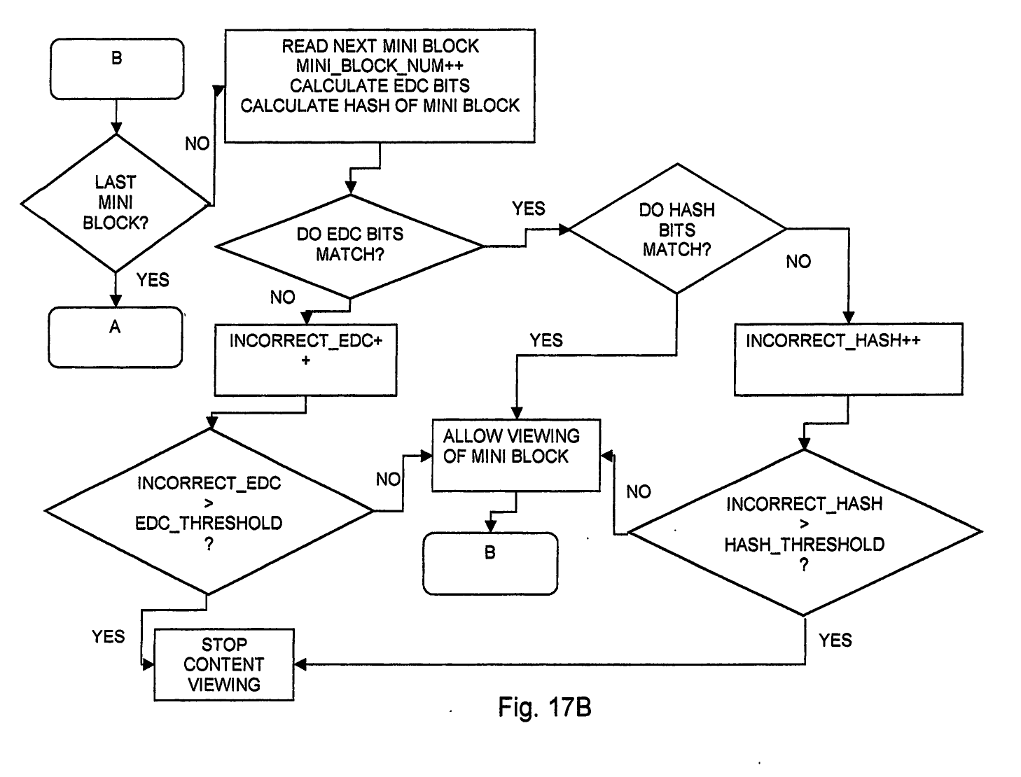

The host also typically sends to the player a content binding vector (CBV) associated with the content, or a separate CBV for each content segment. The CBV is typically sent as part of the CSL of the CL. A preferred method for generating a CBV for a content segment is described in greater detail hereinbelow with reference to FIGS. 16A-17B. The host then sends to the player the content corresponding to the valid CL. The content is encrypted in accordance with the control words contained in the BL-ECM. Prior to writing each content segment to the RMS, the player SRP validates the CBV for each segment. A preferred method for validating a CBV of a content segment is described in greater detail hereinbelow with reference to FIGS. 16A-17B. If the CBV is valid, the player writes the content and the CSL, CUL, and BL-ECM of the content license to the disk. The host also typically sends to the player metadata relating to the content for incorporation into the content list which is written to the RMS. The RMS directory is also updated, signed, and written to the RMS.

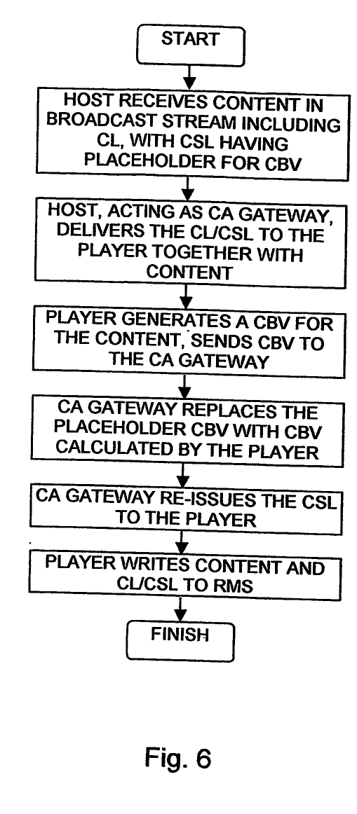

Reference is now made to FIG. 6, which is a simplified flowchart illustration of an exemplary method of writing locally recorded content to an RMS under CA control, operative in accordance with a preferred embodiment of the present invention. Locally recorded content is defined herein as content that originates in a content delivery system, such as televisions signals delivered via transmission tower broadcast, satellite, cable, and xDSL to a host, such as a set-top box (STB). The received content may be stored by the host's Personal Video Recorder (PVR). In the method of FIG. 6, the host receives a CL including a CSL as part of a broadcast stream of content. The CSL contains a placeholder instead of a CBV generated for the content, and is marked accordingly, such as where all bytes of the CBV are set to 0's or where a signal is received via the broadcast stream indicating that the CBV is merely a place holder. The broadcast CSL may arrive at the host encrypted with a control word acquired by the CA Gateway using conventional techniques, where the host typically acts as the CA Gateway, such as by deriving the control word from an ECM sent to the gateway by the broadcaster or via other known CA methods. The CA Gateway then delivers the CL to the player together with content. The player SRP then generates a CBV for the content and sends the CBV back to the CA Gateway, preferably over an encrypted link using conventional techniques. The CA Gateway then replaces the placeholder CBV with the one calculated by the player SRP and re-issues the CSL to the player, replacing the previously provided CSL, whereupon the player may write the content to the RMS along with the CSL as part of the CL. This CSL is preferably signed by the CA Gateway using its signing key. The CA gateway is preferably configured to communicate with the SRP using a predefined SRP protocol, and has access to any certificates, algorithms, and other information required in this regard.

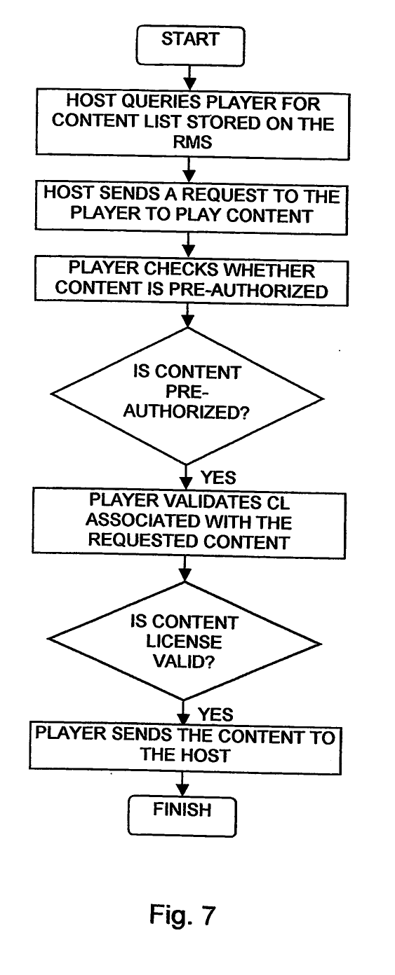

Reference is now made to FIG. 7, which is a simplified flowchart illustration of an exemplary method of playing content stored on an RMS, operative in accordance with a preferred embodiment of the present invention. In the method of FIG. 7, if it hasn't done so previously, the host may query the player as described hereinabove and receive a content list indicating what content is stored on the RMS. The host sends a request to the player to play content, indicating the desired content to be played. The player determines whether the content is pre-authorized, such as by successfully accessing a control word in the BL-ECM for decrypting the content, and, if so, validates all parts of the CL associated with the requested content as described herein to determine if playout to the requesting host is permitted. The player then preferably returns an appropriate response to the host. If CL validation is successful, the player sends the content to the host, typically via an encrypted channel using the same technique used when sending content from the host to the player.

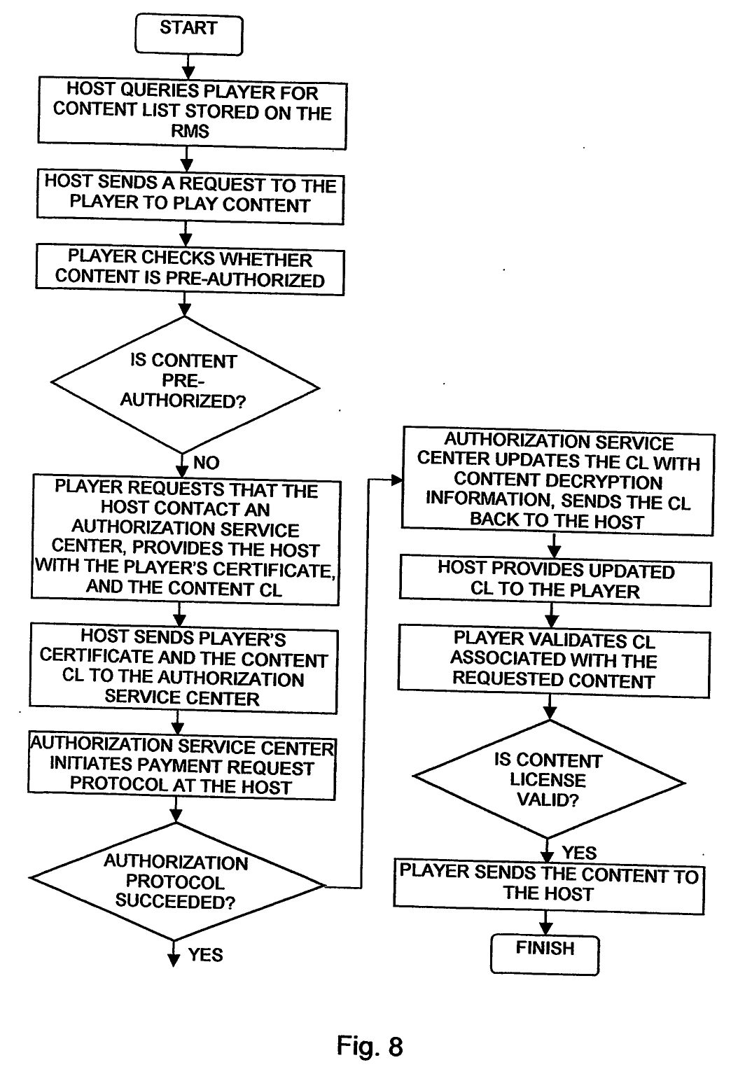

Reference is now made to FIG. 8, which is a simplified flowchart illustration of an exemplary method of playing non-pre-authorized content stored on an RMS, operative in accordance with a preferred embodiment of the present invention. In the method of FIG. 8, if, as described above, the player receives a request from the host to play content stored on the RMS and determines that the content is not pre-authorized, such as by detecting the inability to access the control word in the BL-ECM for decrypting the content, the player preferably requests that the host contact an Authorization Service Center, such as via an Internet connection, whose contact information, such as a URL, is stored on the RMS in the CL corresponding to content for which authorization is sought. The host and Authorization Service Center perform mutual authentication and exchange certificates. The player preferably provides the host with the content CL. The host then preferably sends the player certificate and the content CL to the Authorization Service Center. The Authorization Service Center may initiate any known payment request protocol at the host in order to facilitate the customer's payment for the content. Depending on the user interface approach selected, payment for the authorization may be automatic, such as from payment information stored in the host, or may require user input via an on-screen dialog. The host may then send the payment information to the Authorization Service Center. If the Authorization Service Center chooses to authorize the content access, it uses its own private key to open the CL, updates the CL to indicate its authorization to the player, such as by providing the control word as part of the BL-ECM necessary for decrypting the content, and sends the CL, signed and encrypted for the player, back to the host. The host then provides the updated CL to the player which validates the CL and proceeds as described above with reference to FIG. 7. Alternatively, the user may call the Authorization Service Center directly. In this case, the user provides information such as the RMS Player ID or TV Broadcaster Subscriber ID. The Authorization Service Center prepares the required CL and sends it to the user, such as via the TV broadcaster's EMM stream.

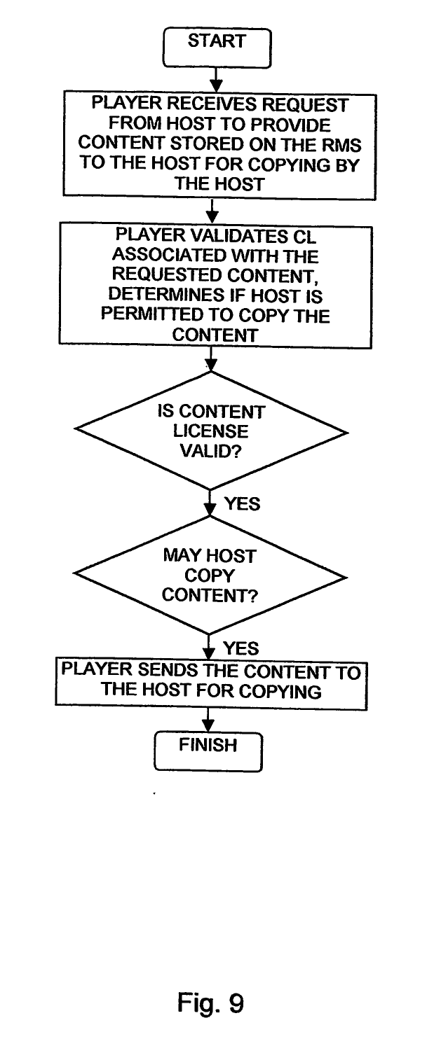

Reference is now made to FIG. 9, which is a simplified flowchart illustration of an exemplary method of writing content stored on an RMS, operative in accordance with a preferred embodiment of the present invention. In the method of FIG. 9, the player receives a request from the host to provide content stored on the RMS to the host for writing by the host, such as to an internal hard disk in the host. As described above for playing stored content, the player validates the CL that is associated with the requested content and that is stored on the RMS to determine if it is permitted to write the content to the requesting host. The player then preferably returns an appropriate response to the host. If CL validation is successful, the player sends the content to the host, typically via an encrypted channel using techniques described herein. If the content is encrypted, the player decrypts the content using the control word stored in the BL-ECM of the validated CL. If required by the CL permissions, the player may generate a new CUL/BL-ECM that is sent to the host together with the content.

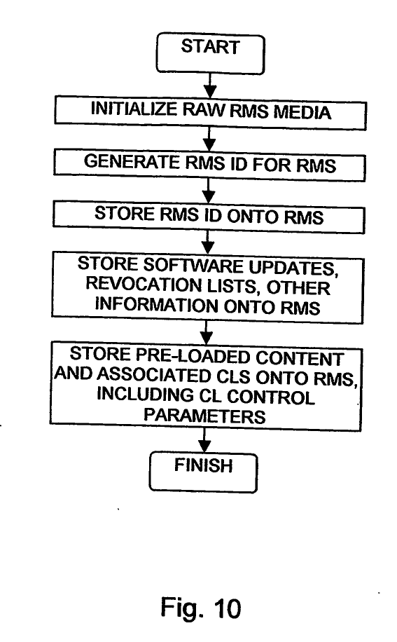

Reference is now made to FIG. 10, which is a simplified flowchart illustration of a method for preparing storage media, operative in accordance with a preferred embodiment of the present invention. In the method of FIG. 10, raw RMS media, being any known write-many or write-once data storage media such as magnetic or optical storage media, are preferably not used until they have been initialized at a secure facility. Initialization typically includes preparing the RMS media so it can be written on, such as by formatting the media using any known technique. The RMS ID described hereinabove is also preferably generated for the RMS media and is stored to the RMS media. Data, such as software updates for the RMS player, revocation lists, and other information may then be written to the RMS. Finally, content and associated CLs may be pre-loaded onto the RMS media. A signed directory and optional content list are also preferably written to the RMS media.

Control parameters included in the CL and enforced by the RMS Control system described herein may be used to control the writing of content to the RMS and sending of recorded content from the RMS player to the host as described hereinabove with reference to FIGS. 4-9, and may include:

a. Private or Domain Use only: indicating that content is restricted to a defined set of players, such as by explicitly indicating SRP IDs. This restriction may indicate that only the defined set of players may play the content, and/or only the defined set of players may record the content to the RMS. The player may identify whether it is part of the defined set of players by checking whether its ID is one of those listed on the RMS.

b. Copy Once: indicating that a particular unit of content may be stored only once to the current RMS and cannot be stored again, although the content may be moved to other storage where the original copy is deleted.

c. SVP Only: indicating that playout of content is restricted to an SVP-compatible host only. The player may identify whether the host is SVP-compatible by checking the host's certificate.

d. Global: indicating that content is playable from any valid RMS Player to any host.

e. Regional Use Only: indicating that content is playable from any valid RMS Player in a permitted region or not in a blocked region. The player may identify whether it is in a valid region by checking its certificate or an internal configuration field indicating such.

f. Global & Preauthorized: indicating that content can be played out from any valid RMS Player to any host if it can be determined that the content was properly bound to the RMS where it is found.

g. Global & Authorized: indicating that content can be played out from any valid RMS Player to any host if authorization for the particular title has been received.

h. Password: indicating that a password is required to access the RMS content. A preferred method for password generation and use is described in greater detail hereinbelow.

i. CA Control: indicating that CA control may be applied in addition to RMS control in accordance with conventional techniques.

j. FED: a final expiration date after which the content may not be used. This is optional and requires access to a secure time source in order to be enforced.

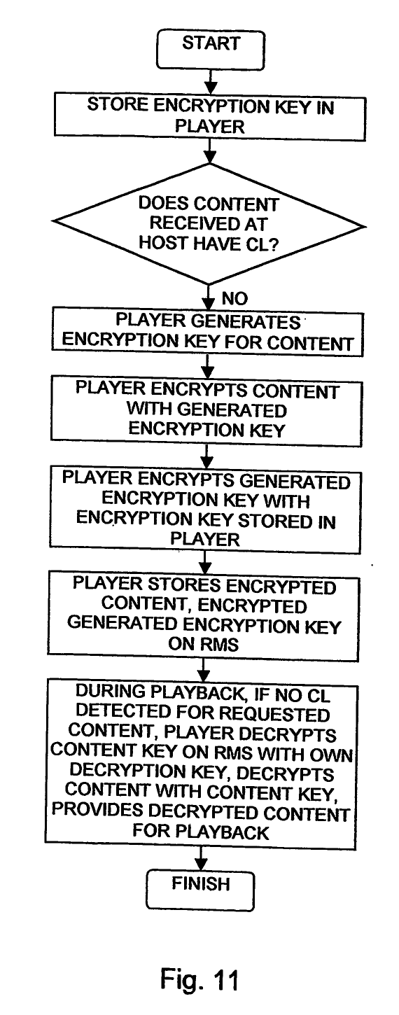

Reference is now made to FIG. 11, which is a simplified flowchart illustration of a method for writing content to an RMS without a CL and reading content therefrom, operative in accordance with a preferred embodiment of the present invention. In the method of FIG. 11, when writing content to an RMS without a CL, content is preferably protected against distribution by using cryptographic means, such as by encrypting the content using a key generated for that purpose that is stored inside the RMS player, the key itself being encrypted using the player's own encryption key, to ensure that the content can only be played out in the same RMS player. When requested to playout content, the player preferably accesses the CL. If no externally-generated CL (e.g., a CL that is received in a broadcast stream together with content) is present, such as where a place-holder CL as described hereinabove is found, the player preferably decrypts the content using the player's internal encryption key to decrypt the CW which is then used to decrypt the content, and sends the content to the host.

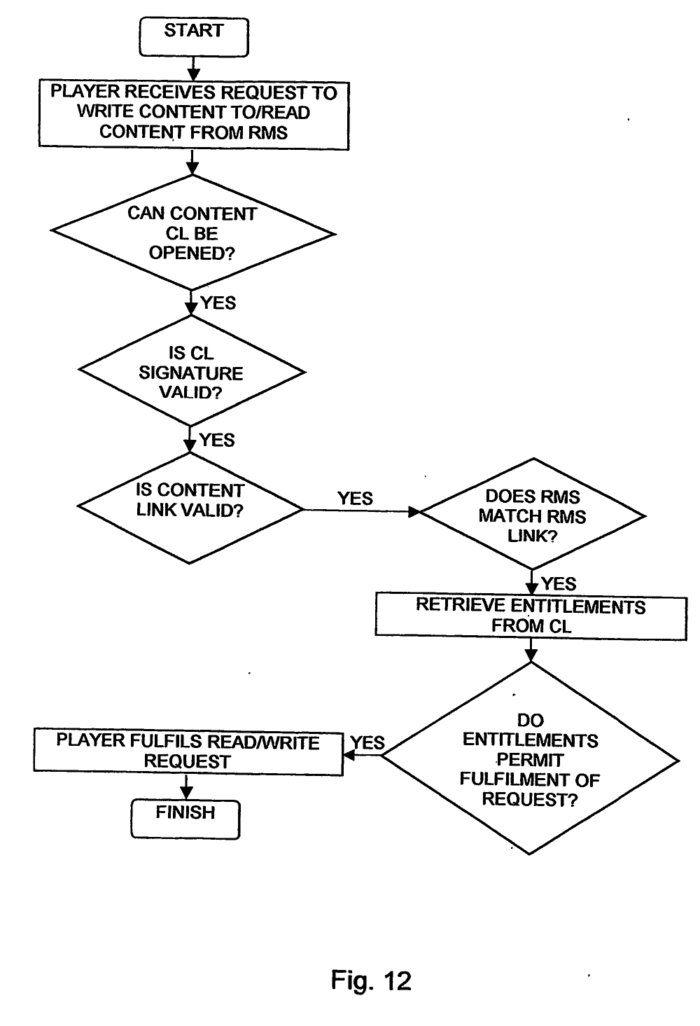

Reference is now made to FIG. 12, which is a simplified flowchart illustration of a method for writing content to an RMS with a CL and reading content therefrom, operative in accordance with a preferred embodiment of the present invention. In the method of FIG. 12, when writing content to an RMS with a CL, the CL is first validated in accordance with methods described herein A valid CL is typically one:
which the player can open (e.g., encrypted using the RMS public key)
whose signature, if present, is valid (i.e., signed by an issuer whose certificate has been checked by the player)
whose content link, if present, is valid (i.e., content matches content link)
whose link to the RMS, if present, is valid (i.e., RMS matches RMS link)
that entitles storage and/or playback of the content to/from the player (e.g., player specifically designated or via global/regional authorization).

Depending on the permissions contained within the CL, the player preferably determines whether the content may be stored on the RMS and if and how the CL should be updated (e.g. from “copy once” to “copy no more” after the content has been copied once). If the CL contains a FED, then the player must locate an authorized time source, such as the broadcast stream or an internal clock, and obtain an authenticated time packet for comparison with the FED. An authenticated time packet preferably consists of a time packet signed according to a certificate known to the player. A time source may be specified by additional information present on the RMS, such as a URL and certificate.

When a request to playout content is received, the player preferably follows the permissions included in the CL to determine whether the content can be played out to this host from this player and under what conditions.

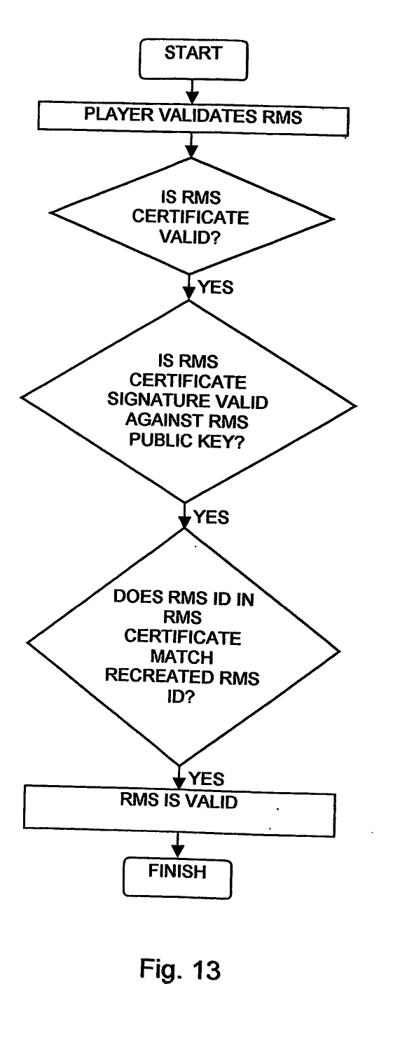

Reference is now made to FIG. 13, which is a simplified flowchart illustration of a method for validating an RMS, operative in accordance with a preferred embodiment of the present invention. In the method of FIG. 13, the player validates the RMS certificate using conventional techniques. The RMS certificate signature is also preferably validated against the RMS public key. The player preferably validates the RMS ID by performing the same algorithm used to create the RMS ID, such as one to determine physical characteristics of the RMS media, and applies the following function used to create the RMS ID public key, namely F (RMS ID)=(RMS−Public−Key). If the generated RMS ID and RMS public key match those stored on the RMS, RMS validation is complete.

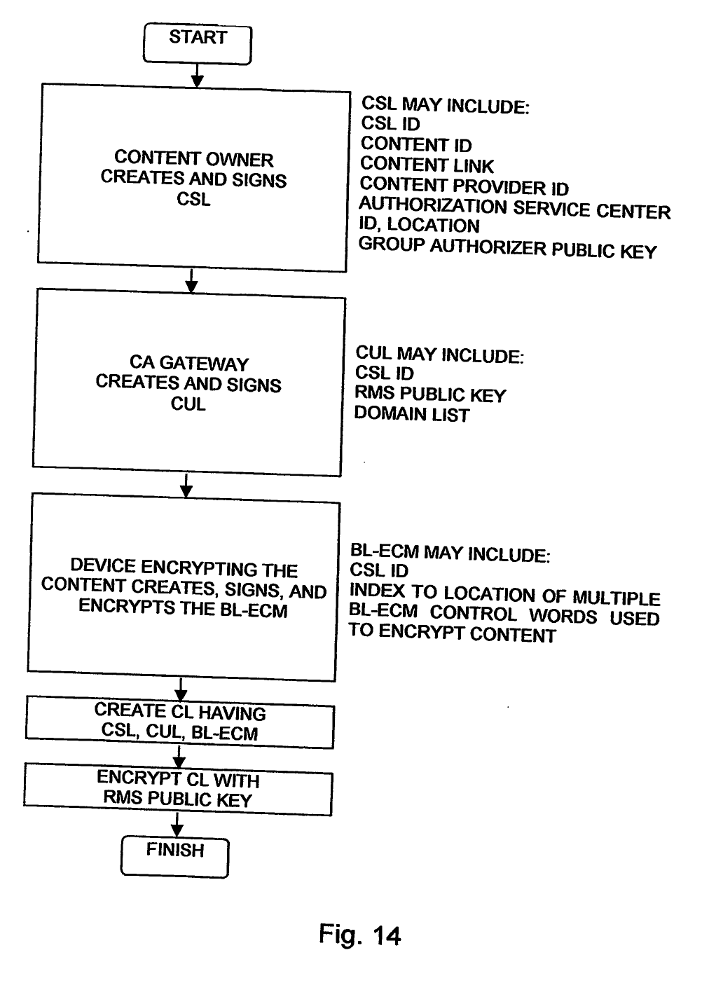

Reference is now made to FIG. 14, which is a simplified flowchart illustration of an exemplary method for generating a content license (CL), operative in accordance with a preferred embodiment of the present invention. In the method of FIG. 14, a CL is created having a Content Segment License (CSL), a Content User License (CUL), and one or more Baseline Entitlement Control Messages (BL-ECM). In one exemplary configuration, the CSL is created and signed by the owner of the content, preferably using the owner's private key. The CSL preferably includes a CSL ID, a content ID identifying its associated content unit, a content link, such as a CBV, and a content provider ID, and may optionally include an Authorization Service Center ID and information regarding its location, such as a URL. The CSL may additionally specify restrictions regarding the use of the content as described herein. The CSL may also include a group authorizer public key. Where a player or RMS is restricted for use, such as only for content from Disney (a content provider) or BSKyB (a broadcaster), then only content whose CSL contains the matching content provider group authorization key will be permitted. The CUL preferably includes the CSL ID for linkage to the CSL, and may also include the RMS public key and a domain list indicating authorized players on which the content may be played. The CUL is preferably created and signed by its creator, such as by a CA smart card in a host STB acting as a gateway. The CUL may additionally be linked to a specific RMS and/or a specific player, such as by encrypting the CUL with the RMS's or player's public key. The CUL may additionally be signed using the group authorizer key held in the CA Gateway where the RMS or player is restricted for use, as is described hereinabove. The BL-ECM preferably includes the CSL ID for linkage to the CSL, and may also include an index linking the BL-ECM to a location in the content where multiple BL-ECMs for the content unit may be found. The BL-ECM also preferably includes a control word used to encrypt the content. The control word may be unique for a given player or may be a common control word to be used by multiple players, such as where global access to content is given. The BL-ECM is preferably created, signed, and encrypted by the device encrypting the content, such as by the host when content is passed from the host to the player, or by the player when storing content to the RMS. The BL-ECM is preferably linked to the CSL by including the CSL ID in the BL-ECM and signing the resulting BL-ECM with a signing key as described hereinbelow. Each CSL preferably has a corresponding CUL. There may be more than one CSL per unit of content, where a different CBV is calculated for each unit of content. There may also be one or more BL-ECMs per CSL. Content may be linked to a particular RMS by encrypting the BL-ECM with the RMS's public key.

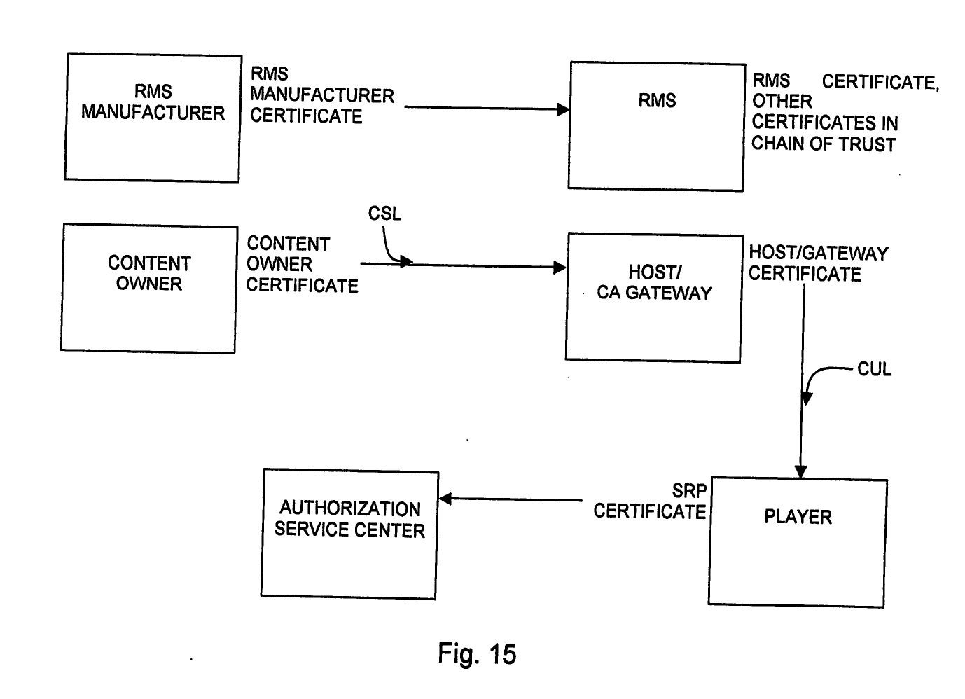

Reference is now made to FIG. 15, which is a simplified conceptual illustration of a certificate infrastructure, constructed and operative in accordance with a preferred embodiment of the present invention. In FIG. 15 various certificates are shown for providing a validated source of public keys with which elements of the present invention described herein may be signed. Certificates may be stored on the RMS along with the content to which they apply. Since a certificate owner might not be available for online inquiry when the content is accessed, a certificate is preferably signed using the RMS private key known only to the RMS manufacturer when the content is written to the RMS. Certificates for the following are typically required:
Certificate for each RMS manufacturer who signs an RMS Certificate. The RMS manufacturer certificate is preferably stored on the RMS;
Certificate for each content owner who signs a CSL. The content owner certificate is preferably delivered together with the CSL;
Certificate for each host/gateway that signs a CUL. The host/gateway certificate is preferably delivered together with the CUL;
Certificate for a player's SRP for the establishment of a secure channel with the host or Authorization Service Center. The SRP certificate is preferably in an SVP-compliant format.

All certificates are preferably signed by a root authority whose public key is stored securely within the player's SRP using conventional techniques, or via a chain of trust from the root key, as is well known in the art.

It will be appreciated that the methods described herein, and the content license in particular, may support various modes of operation of the Player-Host-RMS configuration described herein. These modes of operation are now described.

1. Player-Host-RMS Operation in Support of Private Use.

Private use is defined as writing content from a host device (e.g., a host PVR) to an RMS for personal use. When the player receives content from the host for recording onto the RMS, any restrictions imposed by or on the host may be preserved. For example, where the content is in a format that can only be played out on the host, such as if it is XTV™ content protected by XTV™ PECMs linked to a single smart card, these restriction are preferably preserved. In this context, the write process may be a “move” or a “copy” with no significant distinction, as the RMS copy functions primarily as an archive for the single host. Where the content may be played out on more than one host, the player preferably permits playout to any host, but only from the RMS where the content was recorded. In this context, the write process is preferably a “move” that does not leave an additional copy on the original media, but a “copy” may also be explicitly permitted.

The CL is preferably prepared as follows:

| CL | Data | Security |
|---|---|---|
| CSL | None | None |
| CUL | None | None |
| BL-ECM | Reference to content (e.g., | Signed by & encrypted |
| | Content ID, instead of CSL ID) | for the player using a |
| | Control Word | secret key stored by the |
| | Index to content | player |

2. Player-Host-RMS Operation in Support of Domain Use.

Domain use is defined as writing content from a host device to an RMS while permitting that particular RMS to be used with multiple players in the same domain. The content CL is preferably flagged to indicate that domain use is permitted. A domain may be defined as a set of specific players. The domain may either be fixed per content or per player as follows:
Per Content: Each piece of content may be made available to any player in the domain, and the list of players is preferably set per content at the host. The list of players in the domain may be transmitted to the host together with the content, may be stored at the host, such as in accordance with SVP protocols, or may be generated by the user.
Per Player: Each player is provided with and maintains a list of the players in its domain. Any piece of content that is permitted for use within a domain is permitted to the listed players and no others.

In order to determine the SRP public key required to prepare a CL for other players, each player provides its player ID, either in a human-readable form, such as on a label affixed to the device, via the user interface on the host, or, where domain management is performed internally by players in a domain, as part of the domain management interface between the players. The player ID provides the key for looking up the SRP public key from the listing on the RMS. Where domain management is performed internally by players in a domain, the players preferably exchange their public keys as part of the domain management process, and the RMS table lookup need not be required.

The CL is preferably prepared as follows:

| CL | Data | Security |
|---|---|---|
| CSL | CSL ID | Signed by Owner of content |
| | Content ID | |
| | CBV | |
| | Permissions: Domain | |
| | Optional: Group Authorizer | |
| | Public Key, FED | |
| CUL | CSL ID | Signed by CUL Creator |
| | RMS Public Key | If Group Authorizer Key in |
| | Domain members (list | CSL, also signed by Group |
| | of SRP IDs) | Authorizer |
| BL-ECM | CSL-ID | Signed by SRP where the |
| | Control Word | BL-ECM is written, at the |
| | Index to content | time when the content is |
| | | saved on the RMS |
| | | Encrypted for a particular |
| | | player in the domain using |
| | | the player's public key |

3. Player-Host-RMS Operation in Support of Global Free Copying.

In Global Free Copying the user may be permitted to freely save and play copies of content received via broadcast. Global use content can be saved on an RMS and played out on any RMS Player.

The CL is preferably prepared as follows:

| CL | Data | Security |
|---|---|---|
| CSL | CSL ID | Signed by Owner |
| | Content ID | |
| | CBV | |
| | Permissions: Global, | |
| | regional optional | |
| | Optional: Group | |
| | Authorizer Public | |
| | Key, FED | |
| CUL | CSL ID | Signed by CUL Creator |
| | RMS Public Key not | If Group Authorizer Key in CSL, |
| | required | also signed by Group Authorizer |
| | No SRP List | |
| BL-ECM | CSL-ID | Signed by SRP where written |
| | Control Word | Encryption under globally known |
| | Index to content | SRP key or under RMS public key. |

4. Player-Host-RMS Operation in Support of Regional Control.

In Regional Control regional mappings may be employed in addition to the other operational scenarios described herein. Content received via broadcast may be controlled according to regional restrictions where the RMS Player maintains a record of the region(s) to which it belongs. The term “regions” may include geographic regions or logically defined regions, such as subscribers to a single cable TV provider that might cover several different geographical regions.

5. Player-Host-RMS Operation in Support of Global Copy Once Control.

In Global Copy Once Control the user is permitted to freely save one personal copy of content received via broadcast. The user can read the content freely from the RMS on any RMS Player, but not make additional copies, although a move may be permitted where only one copy is retained. All other conditions that apply to Global Free Copying preferably apply to Global Copy Once.

The CL is preferably prepared as follows:

| CL | Data | Security |
|---|---|---|
| CSL | CSL ID | Signed by Owner |
| | Content ID, CBV | |
| | Permissions: Global | |
| | Copy Once, regional | |
| | optional | |
| | Optional: Group | |
| | Authorizer Public | |
| | Key, FED | |
| CUL | CSL ID | Signed by CUL Creator |
| | RMS Public Key not | If Group Authorizer Key in |
| | required | CSL, also signed by Group |
| | No SRP list | Authorizer |
| BL-ECM | CSL-ID | Signed by SRP where |
| | Control Word | written. |
| | Index to content | Encryption under globally |
| | | known SRP key or under |
| | | RMS public key. |

6. Player-Host-RMS Operation in Support of Global SVP-Only Control.

In Global SVP-Only Control the user is permitted to save a personal copy of the content and to distribute it only to SVP-compliant CE devices for immediate viewing. SVP-compliant devices are trusted not to store content locally or to output it to any other device. All other conditions applying to Global, Copy Once preferably apply to Global, SVP Only.

In Global SVP Only Control the CL preferably contains all data required for an SVP-compliant CL and BL-ECM. The parts of the CL designated for SRP use are identical to Global Copy Once except that the permissions specify SVP Only.

The CL is preferably prepared as follows:

| CL | Data | Security |
|---|---|---|
| CSL | CSL ID | Signed by Owner |
| | Content ID, CBV | |
| | Permissions: SVP Only, Global | |
| | Copy Once, regional optional | |
| | Optional: Group Authorizer | |
| | Public Key, FED | |
| CUL | CSL ID | Signed by CUL Creator |
| | RMS Public Key not required | If Group Authorizer Key |
| | No SRP list | in CSL, also signed by |
| | | Group Authorizer |
| BL-ECM | CSL-ID | Signed by SRP where |
| | Control Word | written. |
| | Index to content | Encryption under globally |
| | | known SRP key or under |
| | | RMS public key. |

7. Player-Host-RMS Operation in Support of Pre-Loaded and Pre-Authorized Content Control.

In this mode the RMS contains pre-loaded and pre-authorized content. Possessing the original disk is the only authorization required, and the RMS may be played in any RMS Player. Playout from the RMS disk can be controlled in any of the following modes:
Read and write freely.
Read only, no copies.
SVP restricted, Immediate View only (no storage).

The CL is preferably prepared as follows:

| CL | Data | Security |
|---|---|---|
| CSL | CSL ID | Signed by Owner |
| | Content ID, CSV | |
| | Permissions: Pre-authorized | |
| | with optional regional | |
| | restrictions; Optional Global | |
| | Free or No Copies or SVP | |
| | Only | |
| | Group Authorizer Public Key, | |
| | Optional FED | |
| CUL | CSL ID | Signed by Group |
| | RMS Public Key | Authorizer (=RMS |
| | No SRP List | Manufacturer) |
| BL-ECM | CSL-ID | Signed by RMS |
| | Control Word | Manufacturer |
| | Index to content | Encrypted under globally |
| | | known SRP key or under |
| | | RMS Public key |

8. Player-Host-RMS Operation in Support of Pre-Loaded But not Pre-Authorized Content Control.

In this mode the RMS contains pre-loaded but not pre-authorized content, and the user is required to purchase individual authorizations for content titles, although the RMS can be played in any RMS Player. Playout from the RMS can be controlled in any of the following modes:
Private use. Additional copies permitted but restricted to this user.
Read only, no copies.
SVP restricted, view immediately only.

The CL is preferably prepared for pre-loading onto the RMS as follows:

| CL | Data | Security |
|---|---|---|
| CSL | CSL ID | Signed by Owner |
| | Content ID, CBV | Encryption for |
| | Permissions: Not Pre- | Authorization Service |
| | authorized with optional | Center |
| | regional restrictions; Optional | |
| | Private Use or Domain or No | |
| | Copies or SVP Only | |
| | Group Authorizer Public Key = | |
| | Authorization Service Center. | |
| | Optional: FED | |
| CUL | CSL ID | Signed by Group |
| | RMS Public Key | Authorizer |
| | No SRP List | |
| BL-ECM | CSL-ID | Signed by Authorization |
| | Control Word | Service Center |
| | Index to content | Encryption for |
| | | Authorization Service |
| | | Center |

The CL is typically sent by the RMS, such as via the Internet, to an Authorization Service Center at a location, such as a URL, specified on the RMS.

The CL is preferably prepared by the Authorization Service Center for return to the SRP as follows:

| CL | Data | Security |
|---|---|---|
| CSL | CSL ID | Signed by Authorization |
| | Content ID, CBV | Service Center |
| | Permissions: Private Use or | Encryption for SRP |
| | Domain or No Copies or SVP | |
| | Only | |
| | Group Authorizer Public Key = | |
| | Authorization Service Center | |
| | Optional: FED | |
| CUL | CSL ID | Signed by Group |
| | RMS Public Key | Authorizer |
| | SRP List - Per Permissions | |
| BL-ECM | CSL-ID | Signed by Authorization |
| | Control Word | Service Center |
| | Index to content | Encryption for SRP |

9. Player-Host-RMS Operation in Support of Local Recording of Content on an RMS Containing Pre-Loaded Content.

In this mode an RMS with pre-loaded content can also be used for locally recorded content, and specifically indicates this. The issuer of an RMS can also specify that the RMS can only be used for its own content. For instance, a broadcaster providing a quarterly magazine on an RMS might only allow content that comes from that broadcaster to be recorded onto the RMS.

10. Player-Host-RMS Operation Integrated with CA Control.

The various methods for RMS control described hereinabove may be integrated with conventional CA control methods. Thus, where an RMS may be used with more than one RMS player as described hereinabove, the user will have to acquire CA entitlements to access the content in addition to ant RMS entitlements required. The initial CL as sent to the SRP typically does not contain a valid CBV. Rather, the CBV is preferably calculated by the SRP and sent back to the CA Gateway. The CA Gateway issues a new CL, where the CSL contains the valid CBV. The BL-ECMs are preferably linked to the CSLs by the CSL ID, and the CBV is linked to the content originally sent by the host. Access to the content is controlled by the CSL ID and control words that appear in the BL-ECMs created by the SRP.

The CL that is sent to the RMS is preferably prepared as follows:

| CL | Data | Security |
|---|---|---|
| CSL | Same as per use case but | Signed by Owner |
| | CBV = Placeholder | |
| | Restrictions: CA Control | |
| CUL | Per Use Case | |
| BL-ECM | CSL-ID | Signed by SRP where |
| | Control Word | written |
| | Index to content | Encryption per public |
| | | keys for each SRP in list |

The CL that is stored on RMS is preferably prepared as follows:

| CL | Data | Security |
|---|---|---|
| CSL | Updated by CA Gateway after | Signed by CA Gateway |
| | CBV calculated by SRP | |
| | CBV = CBV of content as | |
| | stored on RMS | |
| | Restrictions: CA Control | |
| CUL | As received originally from | |
| | Host | |
| BL-ECM | As received originally from | |
| | Host | |

11. Player-Host-RMS Password Control.

A user password for access to content may be provided as an alternative to the CL approach described herein or in addition thereto. For locally recorded content, the user preferably sets the password which will be required for future access to the content to be prompted by the player and viewed preferably on the same user interface screen used for all user interactions. For pre-loaded, non-pre-authorized content, the encryption key for the BL-ECM can be a password provided by the Authorization Server to the user and entered through the application on the host. For both locally recorded and pre-loaded content, once the password has been entered, the password may be stored on the RMS by the RMS player in a secure fashion using conventional techniques. Alternatively, manual entry of the password may be required each time the content is accessed. Password access can be selected on a system basis (e.g., by the CE manufacturer, TV broadcaster or RMS provider) or by the user when creating a new RMS.

Reference is now made to FIGS. 16A and 16B, which are simplified block flow diagrams of a method of creating a Content Binding Vector (CBV) 1600, operative in accordance with a preferred embodiment of the present invention.

The binding of a security system to particular content typically requires that the content remain unaltered. However, in a RMS security system small distortions in the content may occur due to storage and transmission. Moreover, it is well appreciated in the art that content may be altered in an attempt to circumvent security measures. In the present invention a safe distance criteria is defined to represent the degree of distortion by which content may be modified and yet retain its association with its corresponding CBV 1600. The safe distance criteria provides a mechanism for uniquely representing content while ignoring small distortions that may occur within the content due to, for example, physical phenomena in a storage device.

In the method of FIGS. 16A and 16B, content, such as entropy encoded bitstreams 1610 of video 1615 MPEG compressed with codec 1620, is parceled into one or more content blocks 1630, with each content block 1630 receiving its own independently generated CBV 1600. Typically, each content block 1630 represents several Mbits of content, with a typical CBV 1600 being several hundred bits in length and up to few thousand bits.

Each content block 1630 is preferably further divided into one or more content mini blocks 1640. Typically, the number of content mini blocks 1640 in a content block 1630 and the length of the content mini blocks 1640 are selected by balancing the expected error rate against the number of failed transmittable blocks 1660 permitted, with a goal of reducing the length of mini blocks and limiting the size of the CBV 1600. For example, if the ratio between the number of bits dedicated to storage of content and those dedicated for protection and error detection, ie. CBV 1600 and EDC bits 1670, is typically 1000:1, the minimal length of a digital signature for a content mini block 1640 is typically no less than 60 bits, and the average size of the content block 1640 to be protected is C*1,000,000 bits, where C refers to the number of Mbits in a typical segment of content block 1640 e.g. 10, then the typical length of a content mini block 1640 may be calculated using the following formula:
Number of Mini Blocks=10*1,000,000/(60*1000)=˜1660
Typical Length of Mini Block=10*1,000,000/Number of Mini Blocks=˜60,000.

For each content mini block 1640, a digital signature, such as a set of hash bits 1650, is preferably calculated, typically employing a one-way hash function. The hash bits 1650 of each content mini block 1640 in a content block 1630 are preferably combined into a list of digital signatures, such as through concatenation, to form a CBV 1600 for the content block 1630. CBV 1600 may also be asymmetrically signed using an asymmetric signature 1690. The asymmetric signature 1690 of CBV 1600 is preferably chosen from one of the following two options:

1. A special field of several hundred bits up to a few thousand bits dedicated to the asymmetric signature employed to sign the list of signatures of the content mini blocks; or

2. A redundancy string, such as a constant string or a string that is a function of the data, typically 60 to 80 bits in length, though it may exceed this length, employed to sign the list of signatures and the entire content mini block 1640, encrypted with Rabin or RSA like asymmetric encryption schemes.

While the asymmetric signature 1690 may be a single signature for the entire CBV 1600, alternatively, multiple signatures 1690 may be employed, wherein each signature corresponds to a different group of bits within CBV 1600.

Each content mini block 1640 is preferably protected by an error detection code (EDC) 1670 of zero or more bits, which is appended to the content mini block 1640 to form an error detectable block 1680. A failed error detectable block 1680 is one that contains an error in the content bits or in the error detection block bits such that CBV 1600 calculation fails as described hereinbelow. Typically, EDC 1670 is constructed in a manner consistent with the TCP/IP 1-complement checksum technique. Alternatively, EDC 1670 may be constructed following the CCITT standard used for checksums. Signature 1690 stored in CBV 1600 may also be used as an error detection code as well.

The signed CBV 1600 may then be pre-pended to the error detectable block 1680 to construct a storable block 1660.

Reference is now made to FIGS. 17A and 17B, which, taken together, is a simplified flow chart illustration of a method for validating content, operative in accordance with a preferred embodiment of the present invention. In the method of FIGS. 17A and 17B, a set of variables, INCORRECT_SIG, INCORRECT_EDC, INCORRECT_HASH, and MINI_BLOCK_NUM, is preferably initialized prior to the commencement of the iterative process described below. The variables may be employed throughout the iterative process to monitor the progress of the verification of CBV 1600 over time and enforce the safe distance criteria described hereinabove. When signature 1690 stored in CBV 1600 is used as an error detection code as well, such as when no bits are dedicated for error detection codes, the INCORRECT_EDC counter is preferably never incremented and stays fixed at 0, and its corresponding threshold is a number greater than 0.

Signature 1690 of CBV 1600 in storable block 1660 received by the recipient is preferably verified using conventional asymmetric signature verification techniques. Under certain circumstances the validity of CBV 1600 may be verified or decrypted before access to signature 1690 may be enabled, such as, for example, where an RSA or Rabin type of asymmetric signature has been employed. Should signature 1690 be found to be invalid, INCORRECT_SIG is incremented and compared to SIG_THRESHOLD. SIG_THRESHOLD is preferably set to ignore minor infractions of CBV 1600, and is typically set to be a function of the number of content mini blocks 1640 of the content already scanned, the probability for error, the probability for false rejection and the speed with which illegitimate content may be rejected. For example, SIG_THRESHOLD may be set according to the following formula:
SIG_THRESHOLD=A*N+B*C*Square_Root(N)
where A is a constant that attenuates the linear component of the formula, such as 1/1000, N is a function of the number of content mini blocks 1640 already scanned, such as one that would yield the number of scanned CBVs 1600, B is a constant that attenuates the nonlinear component of the formula, such as 1/32, and C is a constant that corresponds to the number of standard deviations for a normal distribution of false rejections, such as 7.

The constants A, B and C preferably depend on parameters that typically do not change during viewing of the content. For example, to set SIG_THRESHOLD_D such that the limit on a false rejection of content is greater than 1:1,000,000,000, C may be set equal to 7. The values of A and B may then be derived as follows:
A corresponds to the probability for failure of the CBV signature check due to an error and is approximately the number of bits required for the CBV 1600 multiplied by the probability of an error, e.g. if the probability for an error is approximately 1:1,000,000 and the CBV 1600 contains approximately 1,000 bits then A may be set to 1/1000.
B corresponds to the estimated standard deviation of the {0,1} valued random variable that detects whether the signature of the CBV is valid or invalid, and may be set equal to the Square_Root(A*(1−A)), which is approximately 1/32 for A= 1/1000.

In the above example, A and B are preferably set such that A is smaller than B, and such that the effect of the non-linear component of the formula described hereinabove is greater than the effect of the linear component. Thus, relative to the other thresholds described hereinbelow, the INCORRECT_SIG is more sensitive over time to its respective threshold, SIG_THRESHOLD.

Should INCORRECT_SIG exceed SIG_THRESHOLD, viewing and/or copying the entire content may be disallowed.

If CBV 1600 signature 1690 is found to be valid, storable block 1660 is broken into its respective content mini blocks 1640 with their respective EDC 1670. The EDC 1670 of each content mini block 1640 may be verified by reconstructing EDC 1670 from content mini block 1640 and comparing the reconstructed EDC 1670 to the corresponding EDC 1670 received as part of storable block 1660. Should an EDC not match its reconstructed EDC, INCORRECT_EDC is incremented and compared to the EDC_THRESHOLD, which is preferably set in a similar manner to the SIG_THRESHOLD as described hereinabove with the parameters A and B set appropriately. For example, sensitivity to EDC_THRESHOLD may be attenuated differently than the sensitivity to SIG_THRESHOLD. With regard to EDC_THRESHOLD, B may be set to be smaller than A to increase the effect of the linear component of the formula described hereinabove and decrease and limit the effect of the non linear component, thus raising the EDC_THRESHOLD over time and limiting its effect. Should INCORRECT_EDC exceed EDC_THRESHOLD, viewing and/or copying the entire content may be disallowed. Should INCORRECT_EDC not exceed EDC_THRESHOLD, viewing and/or copying content mini block 1640 is allowed.

If EDC 1670 matches the reconstructed EDC 1670 of content mini block 1640, the hash bits 1650 of each content mini block 1640 is verified by reconstructing the hash bits 1650 from content mini block 1640 and comparing the reconstructed hash bits to the corresponding hash bits received as part of storable block 1660. Should hash bits 1650 not match its reconstructed hash bits, INCORRECT_HASH is incremented and compared to HASH_THRESHOLD, which is preferably in a similar manner to the SIG_THRESHOLD as described hereinabove with the parameters A and B set appropriately. For example, HASH_THRESHOLD may treated in a manner similar to EDC_THRESHOLD where B is set to be smaller than A to increase the effect of the linear component of the formula described hereinabove and limit the effect of the non-linear component if HASH_THRESHOLD is exceeded, viewing and/or copying of the entire content may be disallowed. Should INCORRECT_HASH not exceed HASH_THRESHOLD, viewing and/or copying the content mini block 1640 is allowed.

When the last content mini block 1640 of storable block 1660 is processed, the iterative process may continue with the next storable block 1660 or until the bitstream is exhausted.

The behavior of the RMS system may be further enhanced with an additional set of verification bits incorporated within CBV 1600 to tie the content to a particular player. These additional bits may correspond to idiosyncrasies found on the recipient's player, such as physical defects in the RMS storage media. Failure to successfully verify content mini blocks 1640 may result in the graded disabling of certain functionality corresponding to an Error Level within the RMS system. For example:
Error Level 0: No action on first n mismatches in a content item, where n is a predefined number, such as two. Alternatively, n may be set as a function of any of the thresholds described hereinabove, such as by setting n equal to a predefined multiple of the average of any or all of the thresholds.

Error Level 1: Prevent copying of content after m mismatches in a content item, where m is a predefined number, such as four, or a function of any of the thresholds described hereinabove.

Error Level 2: Prevent playout after p mismatches in a content item, where p is a predefined number, such as seven, or a function of any of the thresholds described hereinabove.

Error Level 3: Prevent further use of RMS disk after reaching mismatch level 1 (or 2) on q content items, where q is a predefined number, such as two.

The Error Levels are preferably defined as graded functions, more sensitive at the earlier sections of content than later on. For example, 5 mismatches of a CBV 1600 signature 1690 in an entire movie may be permitted, taking into account the length of the movie. However, 5 mismatches during the first 10 seconds of the movie may trigger an Error Level.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A method for protecting content, the method comprising:
providing a host, a player, a communications link between said host and said player for communicating content therebetween, a recordable medium adapted to be played by and recorded to by said player, and an encrypted item of content; and
producing a secure content license corresponding to said item of content, said secure content license comprising:
a key for accessing said item of content;
a permission list for determining whether either of said host and said player is allowed to access said item of content under predefined circumstances, said circumstances including a type of use of said encrypted item of content;
an identification of said recordable medium, said recordable medium identification generated in accordance with a predefined recordable medium identification generation algorithm and describing at least one physical characteristic of said recordable medium; and
an identification of said item of content, said item identification describing at least one data characteristic of said item of content.

2. The method according to claim 1 wherein said providing step comprises storing said item of content on said recordable medium in advance of said player first accessing said content.

3. The method according to claim 2 wherein said storing step comprises storing an indicator on said recordable medium indicating that said item of content is pre-authorized for access by said player.

4. The method according to claim 1 wherein said providing step comprises configuring said host to support Secure Video Processor (SVP) protocols.

5. The method according to claim 1 wherein said providing step comprises configuring said host to receive content via a conditional access (CA) gateway.

6. The method according to claim 1 wherein said providing step comprises configuring said host to support Secure Video Processor (SVP) protocols and receive content via a conditional access (CA) gateway.

7. The method according to claim 1 wherein said providing step comprises configuring said player to support Secure Video Processor (SVP) protocols.

8. The method according to claim 1 wherein said providing step comprises configuring said player to receive CA gateway content from said host.

9. The method according to claim 2 and further comprising:
detecting the presence or absence of an indicator on said recordable medium indicating that said item of content is pre-authorized for access by said player;
requesting, if said indicator is not detected on said recordable medium, authorization for said player to access said item of content.

10. The method according to claim 9 and further comprising:
storing a location indicator of an authorization service center within said content license;
and wherein said requesting step comprises:
sending said content license to said authorization service center at said location;
receiving a modified content license from said authorization service center including an authorization for said player to access said item of content.

11. The method according to claim 10 wherein said storing a location indicator step comprises storing a URL of said authorization service center within said content license.

12. The method according to claim 1 wherein said producing step comprises generating said identification of said item of content as a mathematical function of at least a portion of said item of content.

13. The method according to claim 1 wherein said producing step comprises generating said recordable medium identifier that is unique to said recordable medium in accordance with a predefined statistical likelihood.

14. The method according to claim 13 wherein said generating step comprises generating as part of a formatting process of said recordable medium.

15. The method according to claim 13 and further comprising storing said recordable medium identifier on said recordable medium.

16. The method according to claim 13 and further comprising:
generating a comparison identification of said recordable medium in accordance with said predefined recordable medium identification generation algorithm and describing said at least one physical characteristic of said recordable medium;
comparing said recordable medium identification with said comparison identification; and
validating said recordable medium if said recordable medium identification and said comparison identification are identical within a predefined tolerance.

17. The method according to claim 16 and further comprising preventing access to said recordable medium if said recordable medium identification and said comparison identification are not identical within said predefined tolerance.

18. The method according to claim 1 and further comprising creating a certificate for said recordable medium, said certificate comprising said recordable medium identification and a recordable medium public key.

19. The method according to claim 18 wherein said creating a certificate step comprises creating said recordable medium certificate comprising a list of restrictions indicating permissible uses of said recordable medium.

20. The method according to claim 19 wherein said creating a certificate step comprises creating said restrictions to include any of the following restrictions:
said recordable medium does not allow local recording;
said recordable medium permits local recording; and
said recordable medium permits recording content from at least one specified content provider only.

21. The method according to claim 18 and further comprising signing said recordable medium certificate with a signing key of the manufacturer of said recordable medium.

22. The method according to claim 21 and further comprising validating said recordable medium certificate signature with a public key of said authorized manufacturer or producer of said recordable medium.

23. The method according to claim 1 and further comprising storing a certificate for the manufacturer of said recordable medium certificate on said recordable medium.

24. The method according to claim 23 and further comprising signing a chain of certificates from said recordable medium manufacturer's certificate to a root certificate with a corresponding chain of signing keys

25. The method according to claim 24 and further comprising storing said chain of certificates on said recordable medium.

26. The method according to claim 23 and further comprising signing any of said chain of certificates with a recordable medium private key.

27. The method according to claim 23 and further comprising validating said chain of certificates with corresponding chain of public keys.

28. The method according to claim 1 wherein said providing step comprises providing said recordable medium having any of the following:
a list of revoked devices;
a software update for said player;
a data update for said player; and
a list of public keys of other devices for encrypting any items of content on said recordable medium or other recordable media for use with said other devices.

29. The method according to claim 1 wherein said producing step comprises producing said secure content license having:
a Content Segment License (CSL) corresponding to a specific segment of said unit of content,
a Content User License (CUL) specifying user permissions with respect to said unit of content, and
a Baseline Entitlement Control Message (BL-ECM) including an indication of a control word for decrypting said unit of content.

30. The method according to claim 1 and further comprising:
creating a directory of data stored on said recordable medium; and
signing said directory with either of a signing key of an authorized manufacturer of said recordable medium where said content is pre-loaded onto said recordable medium, and a secure processor key of said player where said content is stored to said recordable medium by said player.

31. The method according to claim 1 and further comprising configuring said player to receive content from said host for recording onto said recordable medium, and to receive from said host a content restriction imposed by or on said host for preserving by said player.

32. The method according to claim 31 wherein said configuring step comprises configuring said player to permit playout of content received from said host to any of a plurality of hosts exclusively from said recordable medium where said content restriction indicates that content may be played out via a plurality of hosts.

33. The method according to claim 1 and further comprising:
rendering said content exclusively accessible to at least one player in a domain of players; and
storing said item of content onto said recordable medium.

34. The method according to claim 33 wherein said rendering and storing steps are performed by said player.

35. The method according to claim 33 wherein said rendering step comprises any of transmitting a list of players in said domain to the host together with said content, storing said list at said host, and receiving said list generated by a user.

36. The method according to claim 35 wherein a plurality of public keys corresponding to said list of players are read from a list stored on said recordable media of corresponding player IDs for selection by a user via either of a label affixed to said player and a user interface menu.

37. The method according to claim 35 wherein a plurality of public keys corresponding to said list of players are received from each of said players belonging to said domain.

38. The method according to claim 1 and further comprising:
storing said item of content on said recordable medium where said content is received via broadcast, multicast or unicast; and
configuring either of said recordable medium and said content to allow playback of said content stored on said recordable medium by any player.

39. The method according to claim 1 and further comprising:
configuring said content with a regional restriction specifying at least one region that is allowed to or disallowed from accessing said content; and
configuring said player to maintain a record of the regions to which it belongs and allow either of storage and playback of said content where said player belongs to said region specified in said regional restriction.

40. The method according to claim 39 wherein said configuring content step comprises specifying either of a geographic region and a logically defined region.

41. The method according to claim 1 and further comprising:
storing said item of content on said recordable medium; and
configuring either of said recordable medium and said content to allow playback of said content stored on said recordable medium by any player and to prevent subsequent storage of said content onto another device.

42. The method according to claim 1 and further comprising configuring said player to permit a personal copy of said content to be stored to recordable medium and distributed only to an SVP-compliant device for immediate viewing thereat, wherein said SVP-compliant device is configured to prevent local storing of said content or output of said content to any other device.

43. The method according to claim 42 and further comprising configuring said content license to include data required for an SVP-compliant content license and BL-ECM.

44. The method according to claim 1 and further comprising configuring said recordable medium to permit storage thereto of content originating exclusively from a predefined source.

45. The method according to claim 1 wherein said providing step comprises storing said item of content on said recordable medium in advance of said player first accessing said content, and wherein said configuring step comprises configuring said recordable medium to permit storage thereto of content originating exclusively from the source of said stored content.

46. The method according to claim 1 and further comprising:
associating a password with said content; and
configuring either of said player and said host to receive and validate said password prior to permitting access to said content.

47. The method according to claim 46 and further comprising:
storing said item of content on said recordable medium in advance of said player first accessing said content, where said content is non-pre-authorized content; and
decrypting with said password received from an authorization center a BL-ECM including a control word for decrypting said content.

48. The method according to claim 1 and further comprising configuring said player to disallow access to said content if a current date received from an authorized time source is later than a final expiration date specified in said content license.

49. The method according to claim 1 and further comprising configuring said player to permit access to said content if a current date received from an authorized time source is not later than a final expiration date specified in said content license.

50-87. (canceled)

88. A content protection system comprising:
a host;
a player;
a communications link between said host and said player for communicating content therebetween;
a recordable medium adapted to be played by and recorded to by said player;
an encrypted item of content; and
means for producing a secure content license corresponding to said item of content, said secure content license comprising:
a key for accessing said item of content;
a permission list for determining whether either of said host and said player is allowed to access said item of content under predefined circumstances, said circumstances including a type of use of said encrypted item of content;
an identification of said recordable medium, said recordable medium identification generated in accordance with a predefined recordable medium identification generation algorithm and describing at least one physical characteristic of said recordable medium; and
an identification of said item of content, said item identification describing at least one data characteristic of said item of content.

89. The system according to claim 88 wherein said item of content is stored on said recordable medium in advance of said player first accessing said content.

90. The system according to claim 89 and further comprising an indicator stored on said recordable medium indicating that said item of content is pre-authorized for access by said player.

91. The system according to claim 88 wherein said host is configured to support Secure Video Processor (SVP) protocols.

92. The system according to claim 88 wherein said host is configured to receive content via a conditional access (CA) gateway.

93. The system according to claim 88 wherein said host is configured to support Secure Video Processor (SVP) protocols and receive content via a conditional access (CA) gateway.

94. The system according to claim 88 wherein said player is configured to support Secure Video Processor (SVP) protocols.

95. The system according to claim 88 wherein said player is configured to receive CA gateway content from said host.

96. The system according to claim 89 wherein said player is configured to:
detect the presence or absence of an indicator on said recordable medium indicating that said item of content is pre-authorized for access by said player, and
request, if said indicator is not detected on said recordable medium, authorization for said player to access said item of content.

97. The system according to claim 96 and further comprising:
a location indicator of an authorization service center stored within said content license;
and wherein said player is configured to:
send said content license to said authorization service center at said location, and
receive a modified content license from said authorization service center including an authorization for said player to access said item of content.

98. The system according to claim 97 wherein said location indicator comprises a URL of said authorization service center.

99. The system according to claim 88 wherein said identification of said item of content is a mathematical function of at least a portion of said item of content.

100. The system according to claim 88 wherein said recordable medium identifier is unique to said recordable medium in accordance with a predefined statistical likelihood.

101. The system according to claim 100 wherein said recordable medium identifier is generated as part of a formatting process of said recordable medium.

102. The system according to claim 100 wherein said recordable medium identifier is stored on said recordable medium.

103. The system according to claim 100 wherein said player is configured to:
generate a comparison identification of said recordable medium in accordance with said predefined recordable medium identification generation algorithm and describing said at least one physical characteristic of said recordable medium,
compare said recordable medium identification with said comparison identification, and
validate said recordable medium if said recordable medium identification and said comparison identification are identical within a predefined tolerance.

104. The system according to claim 103 wherein said player is configured to prevent access to said recordable medium if said recordable medium identification and said comparison identification are not identical within said predefined tolerance.

105. The system according to claim 88 and further comprising a certificate for said recordable medium, said certificate comprising said recordable medium identification and a recordable medium public key.

106. The system according to claim 105 wherein said recordable medium certificate comprises a list of restrictions indicating permissible uses of said recordable medium.

107. The system according to claim 106 wherein said restrictions include any of the following restrictions:
said recordable medium does not allow local recording;
said recordable medium permits local recording; and
said recordable medium permits recording content from at least one specified content provider only.

108. The system according to claim 105 wherein said recordable medium certificate is signed with a signing key of the manufacturer of said recordable medium.

109. The system according to claim 108 wherein said player is configured to validate said recordable medium certificate signature with a public key of said authorized manufacturer or producer of said recordable medium.

110. The system according to claim 88 and further comprising a certificate for the manufacturer of said recordable medium certificate stored on said recordable medium.

111. The system according to claim 110 and further comprising a signed chain of certificates from said recordable medium manufacturer's certificate to a root certificate having a corresponding chain of signing keys

112. The system according to claim 111 wherein said chain of certificates is stored on said recordable medium.

113. The system according to claim 110 wherein any of said chain of certificates is signed with a recordable medium private key.

114. The system according to claim 110 wherein said player is configured to validate said chain of certificates with corresponding chain of public keys.

115. The system according to claim 88 wherein said recordable medium comprises any of the following:
a list of revoked devices;
a software update for said player;
a data update for said player; and
a list of public keys of other devices for encrypting any items of content on said recordable medium or other recordable media for use with said other devices.

116. The system according to claim 88 wherein said secure content license comprises:
a Content Segment License (CSL) corresponding to a specific segment of said unit of content,
a Content User License (CUL) specifying user permissions with respect to said unit of content, and
a Baseline Entitlement Control Message (BL-ECM) including an indication of a control word for decrypting said unit of content.

117. The system according to claim 88 and further comprising a directory of data stored on said recordable medium, wherein said directory is signed with either of a signing key of an authorized manufacturer of said recordable medium where said content is pre-loaded onto said recordable medium, and a secure processor key of said player where said content is stored to said recordable medium by said player.

118. The system according to claim 88 wherein said player is configured to receive content from said host for recording onto said recordable medium, and to receive from said host a content restriction imposed by or on said host for preserving by said player.

119. The system according to claim 118 wherein said player is configured to permit playout of content received from said host to any of a plurality of hosts exclusively from said recordable medium where said content restriction indicates that content may be played out via a plurality of hosts.

120. The system according to claim 88 wherein said content is rendered exclusively accessible to at least one player in a domain of players, and is stored onto said recordable medium.

121. The system according to claim 120 wherein said player is configured to render said content exclusively accessible to said at least one player, and store said content onto said recordable medium.

122. The system according to claim 120 and further comprising a list of players in said domain.

123. The system according to claim 120 wherein said player is configured to transmit a list of players in said domain to said host together with said content.

124. The system according to claim 120 wherein said host is configured to store a list of players in said domain at said host.

125. The system according to claim 120 and further comprising a list of players in said domain generated by a user.

126. The system according to claim 122 and further comprising a plurality of public keys corresponding to said list of players and stored on said recordable media of corresponding player IDs for selection by a user via either of a label affixed to said player and a user interface menu.

127. The system according to claim 122 wherein a plurality of public keys corresponding to said list of players is received from each of said players belonging to said domain.

128. The system according to claim 88 wherein said item of content is stored on said recordable medium where said content is received via broadcast, multicast or unicast, and wherein either of said recordable medium and said content are configured to allow playback of said content stored on said recordable medium by any player.

129. The system according to claim 88 wherein said content includes a regional restriction indicator specifying at least one region that is allowed to or disallowed from accessing said content, and wherein said player is configured to maintain a record of the regions to which it belongs and allow either of storage and playback of said content where said player belongs to said region specified in said regional restriction.

130. The system according to claim 129 wherein said regional restriction indicator specifies either of a geographic region and a logically defined region.

131. The system according to claim 88 wherein said content is stored on said recordable medium, and wherein either of said recordable medium and said content are configured to allow playback of said content stored on said recordable medium by any player and to prevent subsequent storage of said content onto another device.

132. The system according to claim 88 wherein said player is configured to permit a personal copy of said content to be stored to recordable medium and distributed only to an SVP-compliant device for immediate viewing thereat, and wherein said SVP-compliant device is configured to prevent local storing of said content or output of said content to any other device.

133. The system according to claim 132 wherein said content license includes data required for an SVP-compliant content license and BL-ECM.

134. The system according to claim 88 wherein said recordable medium is configured to permit storage thereto of content originating exclusively from a predefined source.

135. The system according to claim 88 wherein said item of content is stored on said recordable medium in advance of said player first accessing said content, and wherein said recordable medium is configured to permit storage thereto of content originating exclusively from the source of said stored content.

136. The system according to claim 88 and further comprising a password associated with said content, and wherein either of said player and said host are configured to receive and validate said password prior to permitting access to said content.

137. The system according to claim 136 wherein said item of content is stored on said recordable medium in advance of said player first accessing said content, wherein said content is non-pre-authorized content, and wherein said player is configured to decrypt with said password received from an authorization center a BL-ECM including a control word for decrypting said content.

138. The system according to claim 88 wherein said player is configured to disallow access to said content if a current date received from an authorized time source is later than a final expiration date specified in said content license.

139. The system according to claim 88 wherein said player is configured to permit access to said content if a current date received from an authorized time source is not later than a final expiration date specified in said content license.

140-177. (canceled)

178. A content protection system comprising:
a host;
a player;
means for communicating content between said host and said player;
a recordable medium adapted to be played by and recorded to by said player;
an encrypted item of content; and
means for producing a secure content license corresponding to said item of content, said secure content license comprising:
means for accessing said item of content;
means for determining whether either of said host and said player is allowed to access said item of content under pre-defined circumstances, said circumstances including a type of use of said encrypted item of content;
means for identifying said recordable medium, said recordable medium identification generated in accordance with a predefined recordable medium identification generation algorithm and describing at least one physical characteristic of said recordable medium; and
means for identifying said item of content, said item identification describing at least one data characteristic of said item of content.
